(19) United States
(12) Patent Application Publication
(10) Pub. No.: US 2010/0324945 A1
(43) Pub. Date: Dec. 23, 2010

(54) DATA INSURANCE SYSTEM BASED ON DYNAMIC RISK MANAGEMENT

(76) Inventor: Ronald Paul Hessing, Barranquilla (CO)

Correspondence Address: EDWARDS ANGELL PALMER & DODGE LLP, P.O. BOX 55874, BOSTON, MA, 02205, US

(21) Appl. No.: 12/778,677

(22) Filed: May 12, 2010

Related U.S. Application Data
(60) Provisional application No. 61/177,523, filed on May 12, 2009.

(51) Int. Cl. G06Q 40/00

(52) U.S. Cl. 705/4

(57) ABSTRACT

A data insurance system with risk management, this risk management bases itself on a risk calculation algorithm targeted to digital data loss of computers and digital storage media. The risk is calculated using an algorithm based on S.M.A.R.T variables, O.S. variables, Anti-virus variables, Backup variables, S.N.M.P variables, Hardware variables and customer's behavior variables. The insurance coverage changes dynamically depending on the status of these variables, in addition, this data insurance system is able to create new rules of risk calculation in order to put the risk level of the customer's computer in red, orange or green, and it's able to auto-detects new trends based on the stats of the AIRC system.

### CROSS-REFERENCE TO RELATED APPLICATIONS

This application claims priority to U.S. Provisional Patent Application No. 61/177,523, filed May 12, 2009, which is incorporated herein by reference.

### BACKGROUND OF THE INVENTION

The present disclosure is in the technical field of insurance. More particularly, the present disclosure is in the technical field of data insurance.

A research on data loss and its cost performed in 2003 by David M. Smith, PhD from the Pepperdine University of California, reports that approximately U.S. Pat. No. 4,607,100 computers in United States suffered at least one episode of data loss that year. It also reports that the cost of these episodes reached $18.2 billion, leading some companies to bankruptcy. For families the loss of pictures or videos from birth, birthdays, holidays, home finance, tax declarations, e-mail and other types of data may constitute a disaster of incalculable sentimental value. Therefore the data loss represents a serious risk for companies and for all computer users in general.

Currently data insurance is offered to customers in the following ways; 1. without considering the management of risks of data loss; 2. considering the risks but using methods that were not designed for handling the risks on computer systems; and 3. considering the risks but using static methods not able to adapt themselves to constantly changing technological and environmental conditions.

An example of such systems is proposed in U.S. Pat. No. 7,386,463 issued Jun. 10, 2008 to Ron McCabe and entitled DATA/PRESENCE INSURANCE TOOLS AND TECHNIQUES, which is incorporated herein by reference (hereinafter the McCabe patent). The McCabe patent presents an invention on how to implement a data insurance system with third-party providers for the technical services and the calculation of the premium and coverage of data insurance mainly based in two methods: the Pure Premium and the Loss Ratio Premium method. A special feature of the McCabe patent consists in collecting the results of Antivirus scan, data mirroring, geographical spread and recovery time, and using them as input for the Pure Premium and Loss Ratio Premium methods in order to calculate the premium to be paid for insurance coverage.

Risk management of the digital data loss over computer systems cannot be handled as risk management for car or home insurances and this method is therefore not unique and useful.

Although the premium estimation gives an idea of the risk of data loss, the risk calculation methods for data insurance services must follow new precise technical guidelines to be able to eliminate the risks and as a consequence bring down the premium. In this sense, calculating the risk of data loss for an entire computer system by only considering the variable types specified in the McCabe patent is not enough to take the measures to actually influence said risk. As a matter of fact, the risk management of data loss in computer systems is not effective when it is not dynamic. This is because computer systems change constantly with the introduction of new hardware, software and the definition of new standards. Therefore, an effective data loss risk management system must be updated and improved constantly as response for new hardware, new software, changing environment, change in usage, new configurations causing new threats and new risk types which rise up over time.

For another example, see U.S. Patent Application Publication No, US 2007/0180328 entitled MONITORING HEALTH OF NON VOLATILE MEMORY, which tries to predict hard disk failures based on the S.M.A.R.T. variables in order to avoid the risk of data loss and is incorporated herein by reference. Although S.M.A.R.T. variables are really useful to know the hard disk health status, having this information is not enough to determine the risk of data loss in a precise way. There exists a combination of factors (over 400) that influence this calculation, for example operating system status, hardware status, hacking activities, viruses, local weather conditions and changing end-user behavior. Additionally, the system proposed in that patent application does not execute any actions in response to a high risk status; instead of that, it only notifies the end user with messages. It does not actively participate in eliminating or decreasing the risk.

There are no well-defined and effective risk management methods.

### SUMMARY OF THE INVENTION

A gap has been identified in the technology related to data insurance or data loss risk calculation and management. The subject technology effectively handles the risk of losing data by taking into account all the possible computer system variables, and which uses new methods, strategies and algorithms that allow the subject technology to dynamically adapt to the constant changes of those and future variables.

The present disclosure is a data insurance system based on the dynamic management of the risk of data loss. This risk management is based on methods and strategies oriented specifically to data insurance on non-volatile memory and computer systems. The risk management system will define, on each moment, the insurance coverage depending on the risk calculation result. Therefore the insurance coverage offered by the present disclosure is dynamic and responds to the changing risk status. The risk calculation of data loss is made by an algorithm which takes into account the Hard disk S.M.A.R.T variables, Operative System status and variables, Anti-virus status and scanning results, S.N.M.P variables, motion sensors for hard disks, shock sensors for the whole computer, (Personal) Firewall rules and alerts, network conditions, local and online backup status and variables of the insured and non-insured data, computer hardware, customer behavior and historical data of millions of users.

In the algorithm, the variables are processed by a group of rules created automatically based on trends detected by the risk detector of the risk management system. But at the same time, these rules can be created manually by a risk management team and added to a database which contains all the rules managed by the risk management system. These rules are updated constantly over time in order to cover new risks requirements. Also, the subject technology is able to execute actions on the customer's computer to bring the risk level back to a green status. These actions are executed by a data insurance service or daemon installed on the customer's computer depending on the rules' results, i.e., if the Spin Up time of the customer's hard disk is less than 60 msec then the risk level goes to orange, and the actions to be taken will be to initiate the local and online backup immediately and show a message recommending that the user exchange the hard disk, then after the risk level goes to red.

The subject technology shows in an operational and technical way how all of the above is performed by presenting the data insurance service, which provides management of the risk of data loss, backup and recovery services and financial damage coverage to the customers. All of this is done in order to decrease the risk of data loss with the target to eliminate the risk of data loss. The backup service API of the subject technology allows integrating the data insurance service with third-party backup providers.

The backup service can also perform backups by itself to several data repositories at the same time by using a Universal Repository Connector which is able to move the customer's backed up data to all datacenters or data repository providers of the customer preference. In this way, the subject technology decreases the risk of data loss when one of the data repositories or third-party online backup providers goes bankrupt, gets confiscated by a government or goes down due to technical issues. In addition to these online backup features, the backup service of the subject technology is able to manage third-party local backup providers and/or carry out local backups in order to offer this mechanism as first defense against data loss.

In one embodiment, the subject technology is directed to a data insurance system with risk management, this risk management bases itself on a risk calculation algorithm targeted to digital data loss of computers and digital storage media. The risk is calculated using an algorithm based on S.M.A.R.T. variables, O.S. variables, Anti-virus variables, Backup variables, S.N.M.P variables, Hardware variables and customer's behavior variables. The insurance coverage changes dynamically depending on the status of these variables, in addition, this data insurance system is able to create new rules of risk calculation in order to put the risk level of the customer's computer in red, orange or green, and it's able to auto-detects new trends based on the stats of the artificial intelligence risk calculator (hereinafter AIRC) system.

The AIRC risk calculation algorithm works with Single Rules which evaluates the status of a single variable of the S.M.A.R.T variables, O.S. variables, Anti-virus variables, Backup variables, S.N.M.P variables, O.S. Firewall Status and alerts, Hardware variables and customer's behavior variables and defines the risk level which can be green, orange, red, this algorithm sets the risk level duration too and this risk level will determines the insurance coverage, when data loss occurs when the risk level is green then a payment must be done to compensate the loss, when the data loss occurs when the risk level is orange then the insurance is limited to one recovery attempt at a specialized laboratory and when is red then the data is not insured, in addition the risk calculation algorithm works with compounded rules which evaluates the resulting risk levels and durations of the group of Single Rules and based on that, these compounds rules will changes or not the risk level and/or extends the risk level duration, this risk management is dynamically and base itself on real technological parameters avoiding the use of traditional methods of premium calculation as the DATA/PRESENCE INSURANCE TOOLS AND TECHNIQUES patent does.

Based on the risk calculation result this Data Insurance System executes expected actions for each AIRC rule which were true, i.e. reboot the computer or starts their own backup immediately or order the third-party backup provider to executes a backup, the backup is able to be done using several backup repositories destinations at the same time, allowing in this way that the customer selects the backup repositories of his preference using the Universal Repository Connector which manage all the protocols defined per each repository provider as once.

In addition the subject technology allows that Third-parties which provides online backup services to connect the Data Insurance System in order to provide the data insurance service by using the risk management of the subject technology through a Third-party API implemented by a RPC protocol which is used by the Third-party to connect the server's side of the subject technology.

In one embodiment, the subject technology is directed to a business model which establishes alliance partnerships with Banks, Insurance Companies, ISP Telecom Companies, Backup providers, Hard drive manufacturers, hard drive case manufacturers, Niche Market, computer manufacturers and retailers. The business model has several ways to make money which are, without limitation: charge their customers for eliminating the risk of data loss with a very low premium, by collecting stats from customer population in order to improve the AIRC risk management system and with this improvements the subject technology will be able to inform the third-parties about common problems regarding their hardware and software in their products and then the data insurance company will ask to be included into the third-parties products in compensation for sharing this valuable data with manufacturers, the data insurance company will be offered by retailers which will returns kickback fee for the sales, in the same way, the data insurance company will charge for resealing third-party services too like online backup services from third-parties, the data insurance company will charge in order to certificate the storage methods and backup models implemented by third-parties, in the same way the data insurance company will charge for certificates PC's, laptops, servers, external cases, data repositories centers, network attached storages, etc., and also the data insurance company will charge other companies for licenses that allows the usage of the subject technology too.

In another embodiment, the subject technology is directed to a method for calculating the risk of data loss comprising the steps of creating a risk management system based on single and multi rules by analyzing statistics of computer failures, wherein the rules define a risk level of a customer computer, generating the risk level using the rules, comparing the risk level to a reference value, determining a status selected from low, medium and high risk of data loss based on the comparison, and assigning the status for a period of time based on one of the single rules.

In still another embodiment, the subject technology is directed to a server for facilitating a diagnostic tool, a backup tool and an insurance service, wherein the server communicates with clients via a distributed computing network. The server comprises a memory storing an instruction set and data related to a plurality of rules defining a risk level of a client, and a processor for running the instruction set, the processor being in communication with the memory and the distributed computing network. The processor is operative to (i) create a risk management system based on the rules by analyzing statistics of computer failures, (ii) generate the risk level using the rules and variables related to the client, (iii) compare the risk level to a reference value, (iv) determine a status selected from low, medium and high risk of data loss based on the comparison, (v) assign the status for a period of time, (vi) calculate an insurance premium related to data files of the client based upon the rules and variables related to the client, and (vii) undertake remedial action when the status is high risk, wherein such action includes backup of the data files.

Still another embodiment is directed to a method of risk detection for assessing loss of data, providing preemptive measures against data loss, and remedial action in an event of data loss. The method includes identifying trends in computer failures based upon previous failure data, creating rules based on the trends, updating the failure data, revising the trends based upon the updated failure data, revising the rules based on the revised trends, applying the rules to a client having client data associated with a customer, applying corrective action to the client computer based upon violation of the rules, providing insurance to the customer based upon the rules, configuration of the client computer, and performance of the client computer.

It should be appreciated that the subject technology can be implemented and utilized in numerous ways, including without limitation as a process, an apparatus, a system, a device, a method for applications now known and later developed or a computer readable medium. These and other unique features of the technology disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIGS. 1A-F are a flow diagram which describes how the Data Insurance Application works and the interrelationships between elements in accordance with the present disclosure.

FIGS. 2A-E are a flow diagram which describes the Risk Calculation algorithm in accordance with the present disclosure.

FIG. 3 is a screenshot showing the first step of the AIRC wizard where the main attributes of a Scenario can be defined in accordance with the present disclosure.

FIG. 4 is a screenshot showing the second step of the AIRC wizard for search Variables that will be used in the Scenario of FIG. 3 in accordance with the present disclosure.

FIG. 5 is a screenshot that shows a list of results of the search of Variables in the AIRC wizard in accordance with the present disclosure.

FIG. 6 is a screenshot of AIRC wizard where the Expressions created for a Scenario are listed in accordance with the present disclosure.

FIG. 7 is a screenshot of the AIRC wizard for the creation of a Single Expression in accordance with the present disclosure.

FIG. 8 is a screenshot of the AIRC wizard for the creation of a Multi Expression in accordance with the present disclosure.

FIG. 9 is a screenshot showing the second step of the AIRC wizard for search Messages that will be used in the Scenario in accordance with the present disclosure.

FIG. 10 is a screenshot that shows a list of results of the search of Messages in the AIRC wizard in accordance with the present disclosure.

FIG. 11 is a screenshot of the AIRC wizard for the creation of a Rule and setting optional pre conditions in accordance with the present disclosure.

FIG. 12 is a screenshot of the AIRC wizard to set the priority of the Rules of a Scenario by ordering the list in accordance with the present disclosure.

FIGS. 13A-C are diagrams describing the technical overview of the Data Insurance System topology in accordance with the present disclosure.

FIGS. 14A and 14B are diagrams describing an overview of how the process of the AIRC rules definition in accordance with the present disclosure.

FIGS. 14[A]C-F are diagrams describing how the process of detecting new risks and trends related with data loss works in accordance with the present disclosure.

FIGS. 15A and 15B are diagrams describing the business model of the data insurance based on the theories presented before in accordance with the present disclosure.

FIGS. 16A-D are diagrams describing an overview of how the process of the AIRC risk detector works.

### BRIEF DESCRIPTION OF THE SUB-ELEMENTS OF THE DRAWINGS

The subject technology overcomes many of the prior art problems associated with data insurance. The advantages, and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

Below is a reference list or legend for the components of the figures for each respective figure by reference numeral.

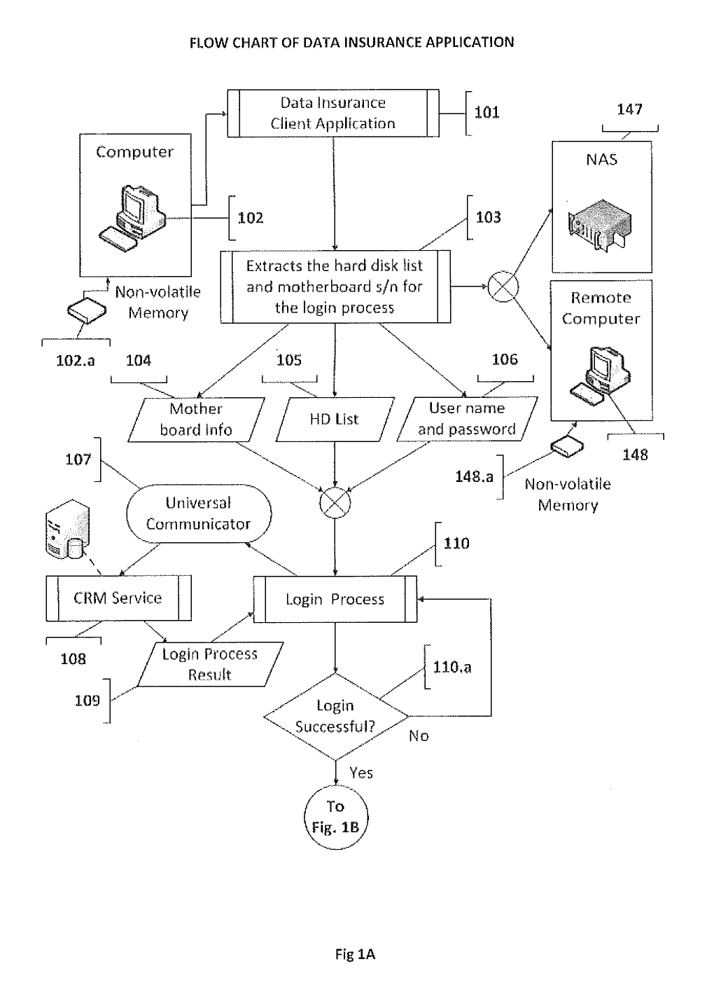

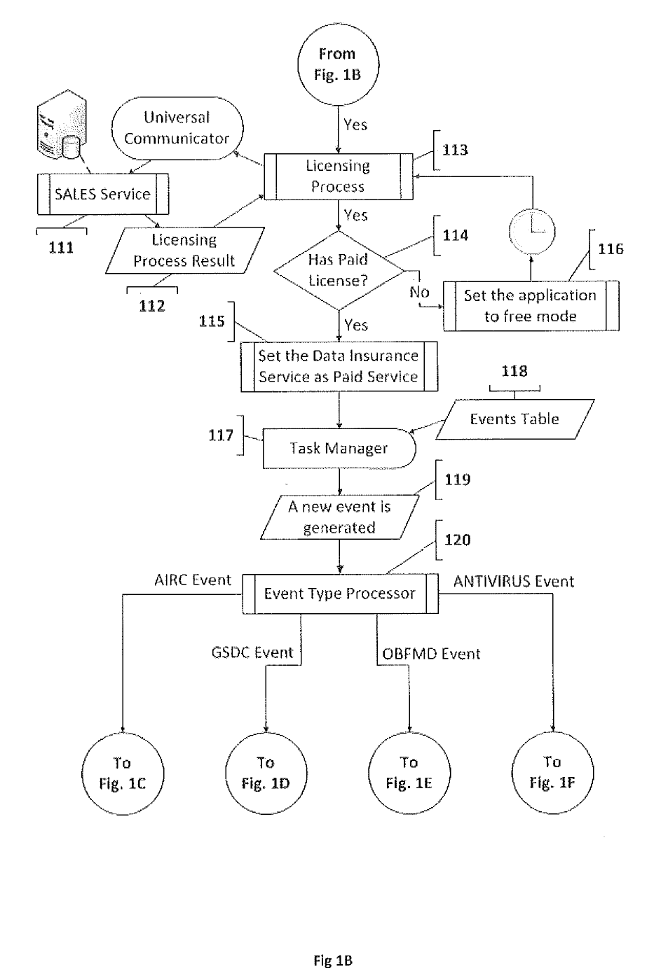

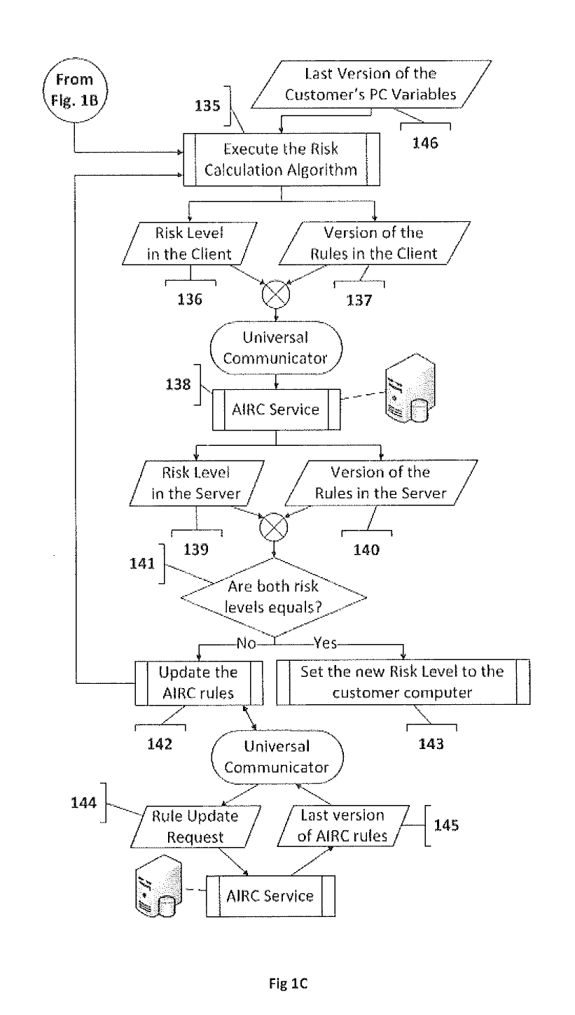

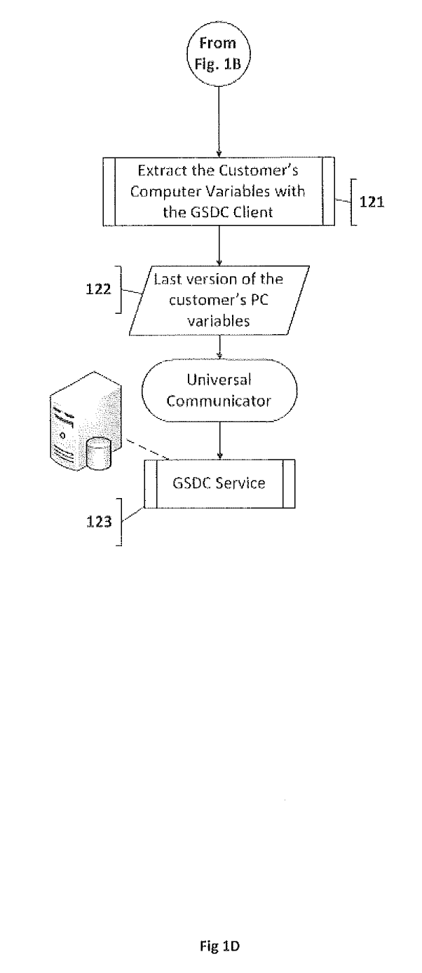

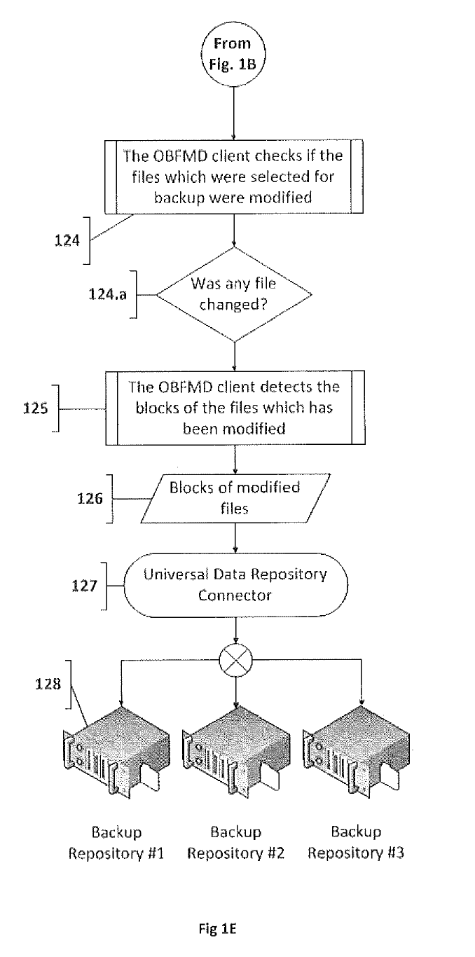

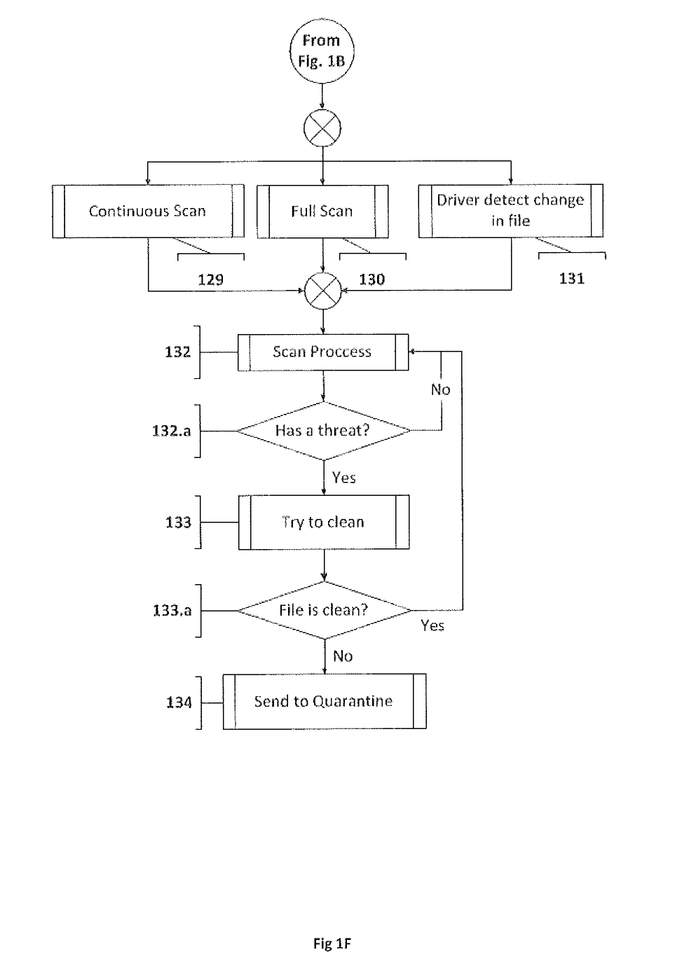

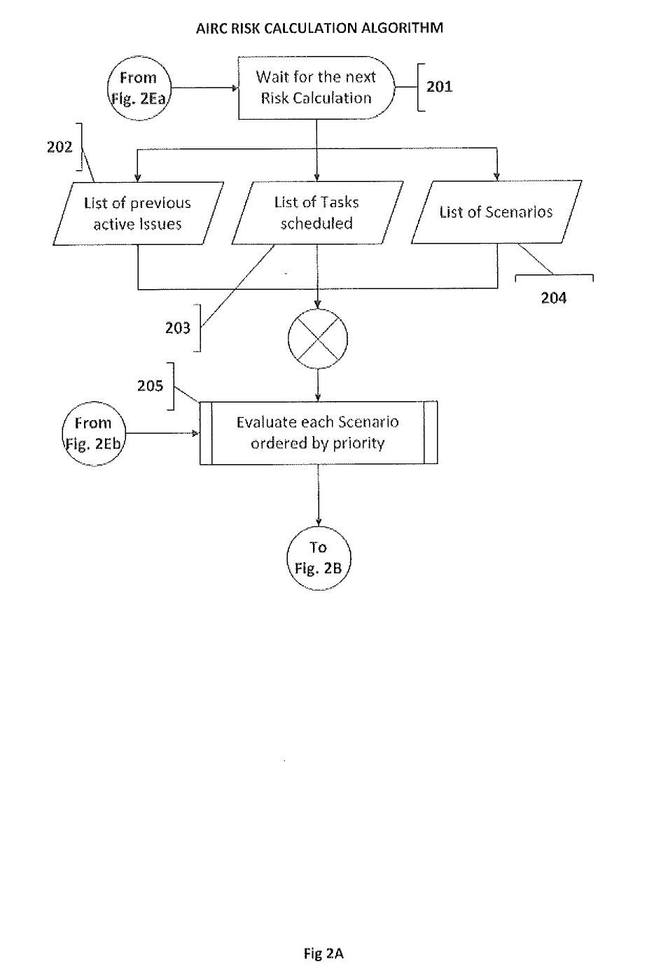

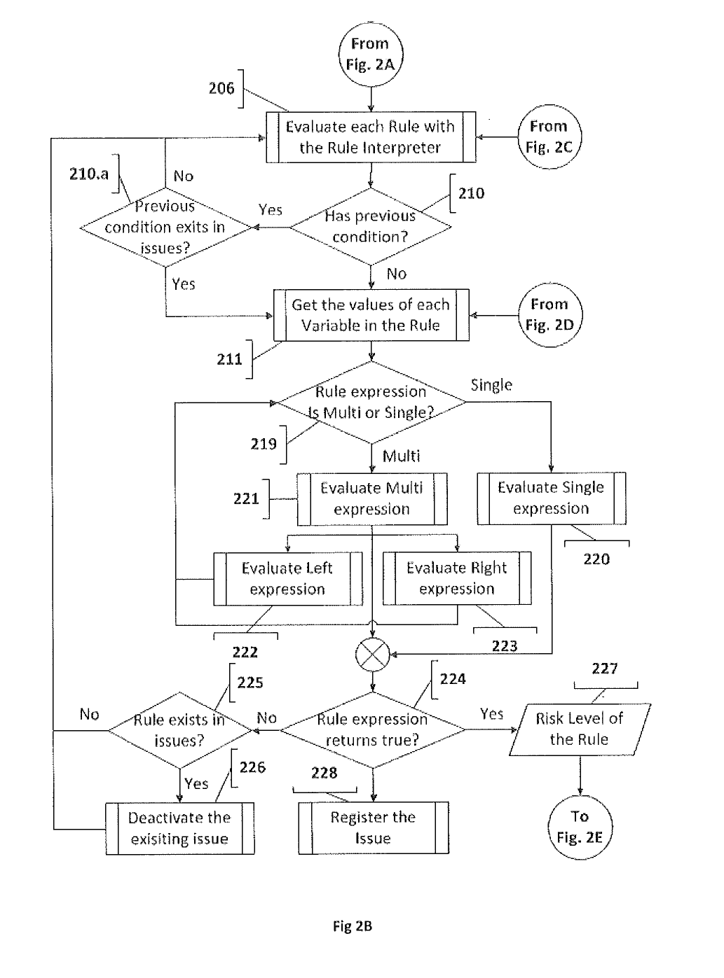

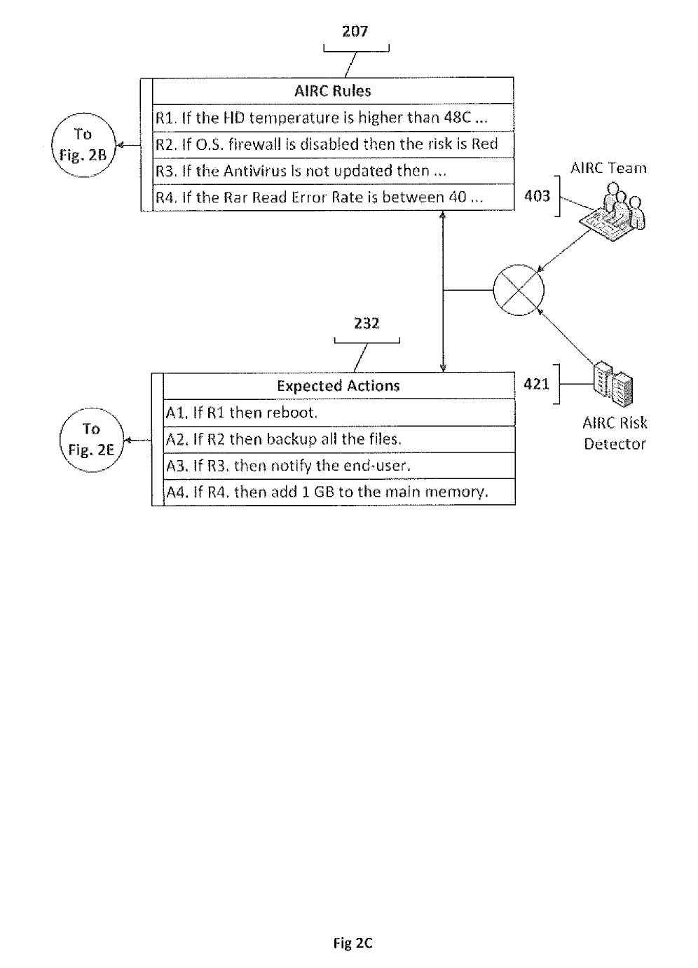

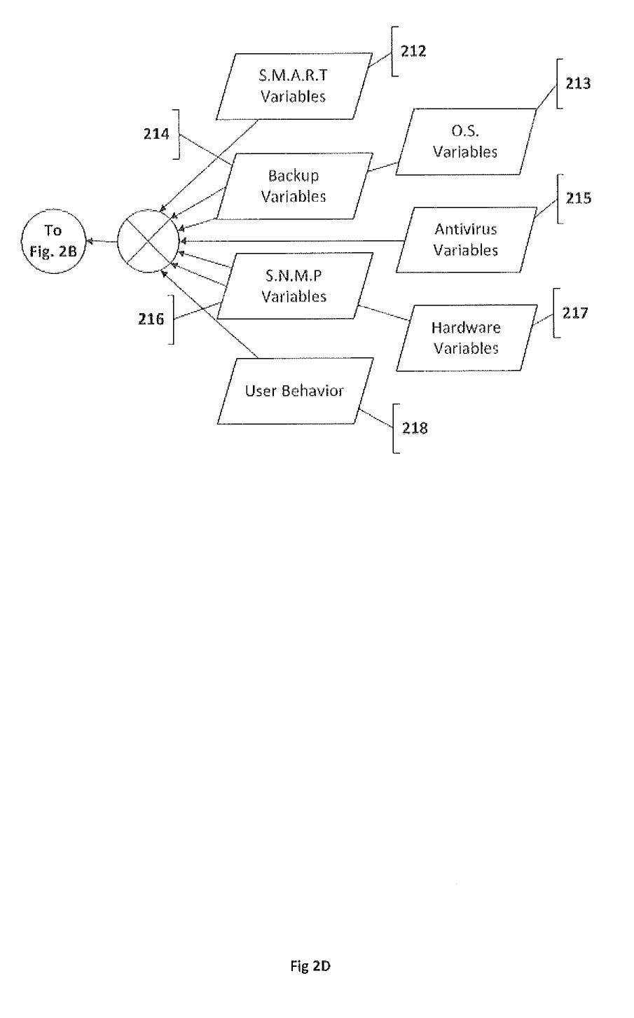

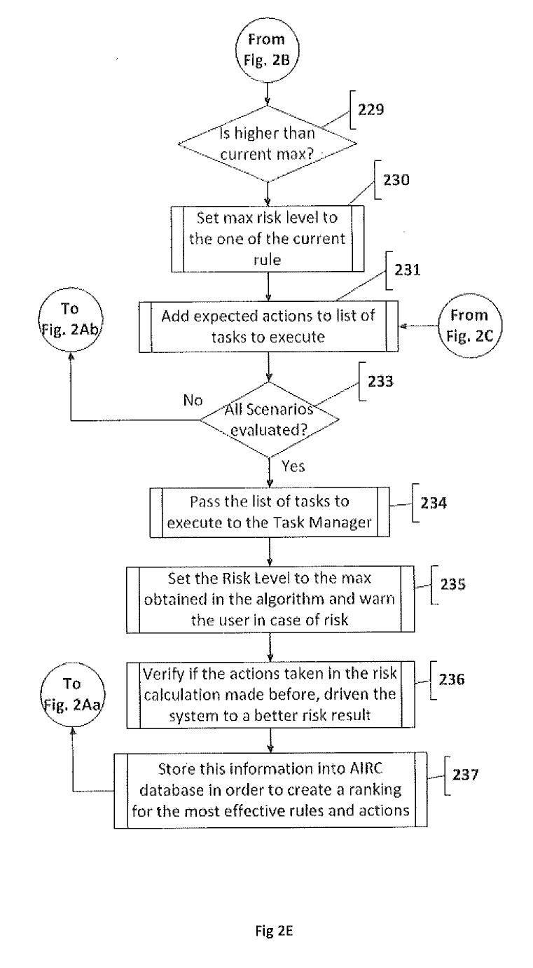

### FIGS. 1A-F

[101] The Data Insurance client application is mainly in charge of the interaction with the customer and customer's computer. This application is composed at an overview level of a GUI and a system service or daemon which runs in the background. There will be a version of this service able to run from a chipset of the motherboard on the pc.

[102] The customer's computer is the system which has the data to be insured. This computer can be a laptop, desktop, server, tablet-pc, hand-held, mobile device and whatever device having memory, processor, storage media and data where the different embodiments of Data Insurance client application 101 can be installed.

[103] Predefined process which extracts the hard disk list, mother board, username and password from the customer's computer 102.

[104] Motherboard information like serial number (S/N), model, brand and manufacturer.

[105] This list contains S/N, model, brand, capacity, connection type, firmware name, firmware version, S.M.A.R.T. capabilities and manufacturer for all the non-volatile memory installed in the customer's computer 102.

[106] The username and password can be extracted from the encrypted database stored at the hard disk in case the end-user selected to save the password, otherwise the username and password will be asked to the end-user.

[107] The Universal Communicator is a module of the Data Insurance client application 101 which allows connecting every kind of service application offered through the network.

[108] In charge of the customer's relationship management. This service implements functionalities like login control, (preventive) support including (personal) phone alerts (from a risk management specialist), SMS alerts, claim requests etc.

[109] The login process result defines whether the information 104 105 106 provided as input to the login process 110 is valid or not in order to continue with the normal process of the Data Insurance Client Application 101.

[110] The login process validates the identity of the customer, validates the computer from which the user is requesting access, and verifies which non-volatile memory the computer has installed.

[111] In charge of the licensing of the software. This service implements functionalities like bill processing and insurance plan management.

[112] The licensing process result defines whether the billing information of the user is valid or not in order to continue with in a free or paid version.

[113] The licensing process validate if the user has a valid license for a hard disk 102.a in his computer 102.

[114] A check if the customer's license is paid or free.

[115] A predefined process which sets the Data Insurance Client Application in insured mode in case the technological conditions and payments are right. In case the customer did not pay for the service (delayed payment) then the AIRC Service 138 contains a rule which results in the risk level Red.

[116] A predefined process which sets the application in free mode, in this mode the user will not have insurance for his data.

[117] The task manager service is in charge of generating events whenever the Data Insurance Client Application 101 needs to perform a task.

[118] This event table is a data structure which contains all possible software events that Data Insurance Client Application can detect and the task that will be executed when it occurs. [119] A new event is released by the task manager service 117 in order to trigger the execution of a task belonging to the 305, 306, 307, 308 or 309 clients running at the Data Insurance Client Application 101.

[120] The event type processor acts as a router specifying which path must be followed by the Data Insurance Client Application i.e., in case the event type belongs to the AIRC client, then the path to be followed will be the AIRC instructions group and the risk of data loss will be calculated.

[121] A predefined process which extracts the customer's computer variables 146, 212, 213, 214, 215, 216, 217, 218 in order to obtain the information to calculate the risk using the AIRC risk calculation algorithm.

[122] The latest version of values for the customer's PC Variables.

[123] The GSDC (General S.M.A.R.T. Data Collection) service is in charge of collecting and storing all the customer computer variables 146, 212, 213, 214, 215, 216, 217, 218 from the customer's computer 102. This service offers this information to the other services such AIRC, OBFMD (Online Backup File Management Database) and CRM services.

[124] A predefined process which checks if the files selected for backup were modified or not. This process implements a file tracking method in order to detect file movements, renaming, creation, modification and deletion.

[125] A predefined process to extract the changed blocks from each file that has been modified.

[126] All changed blocks extracted from the files that were changed.

[127] The Universal Repository connector is a module of the Data Insurance Client application which is able to connect every kind of data repository providers through the Internet VLAN, LAN and other networks.

[128] A backup repository is the place where files and blocks of files are stored for mirroring the insured data remotely.

[129] A type of scan of the antivirus module that executes a light scan over all the files.

[130] A type of scan of the antivirus module that executes a deep scan for all the computer including registry, boot sectors, memory and volumes.

[131] A type of scan of the antivirus module that executes a scan to a file when detects that it was modified.

[132] A predefined process that search possible threats inside a file, registry records, boot sectors or memory.

[133] A predefined process that try to remove malicious code from an infected file.

[134] If an infected file could not be cleaned the file is sent automatically to Quarantine. After that the user will be notified and he will be able to take a decision with the file between: ignore, delete or leave in quarantine.

[135] A predefined process which executes the calculation of risk of data loss by calling the AIRC risk calculation algorithm shown in FIG. 2.

[136] The risk level can be Green, Orange or red, meaning the computer has: minimal risk of data loss, medium risk of data loss and high risk of data loss, respectively.

[Green] The risk level green will cover in case of a loss a data recovery attempt in an specialized data recovery laboratory and if this fails a damage coverage paid out with money.

[Orange] The risk level orange will limit coverage in case of a loss to a data recovery attempt in a specialized data recovery laboratory.

[Red] The risk level Red results in the customer's data is not insured due to high risk and/or not following the instructions given by the client application [101] properly. This can trigger the CRM service 108 for example to call the customer for help and guidance towards [136] level.

[137] A predefined process which verifies the version of the rules (single rules and multi-rules) stored in the Data Insurance Client Application 101.

[138] The AIRC service is located at the server side of the subject technology. This service is in charge of calculating the risk of data loss 139, to offer a GUI interface for the risk management team to create new rules, detecting new risks and create new rules for decreasing the risk of data loss, and giving statistics and information regarding the risk management from all the customers.

[139] This is the risk level calculated by the AIRC service 138. Besides the Data Insurance Client Application 101, the AIRC service 138 recalculates the risk as a security measure to verify the risk calculation done at the Client Application 101.

[140] Version of rules, tasks and messages in the customer's PC.

[141] Check if the both risk levels (Client and Server) are equal.

[142] A predefined process which requests the AIRC Service 138 to download the new version of the AIRC rules through the Secure File Transfer System 107 if there is an available update.

[143] A predefined process which sets a risk level for the customer's computer, this risk level will define the insurance coverage is divided in the levels green, orange and red.

[144] A request sent to the AIRC service 138 in order to receive the new versions of the AIRC rules.

[145] The latest version of AIRC rules for the risk calculation algorithm.

[146] The last version of the customer variables. These variables are extracted from the customer's computer 102, and belong to the following types: Hard disk S.M.A.R.T variables, Operative System status and variables, Anti-virus status and scan results, S.N.M.P variables, motion sensors for hard disks, shock sensors for the whole computer, Personal Firewall rules and alerts, network conditions, local and online backup status and variables 212, 213, 214, 215, 216, 217, 218 for the insured and not insured data, computer hardware and customer behavior variables.

[147] A network attached storage media where a group of users could store files.

[148] Another computer insured in the same network of 102.

### FIGS. 2A-E

[201] A predefined delay which wakes up when the next risk calculation 135 is needed.

[202] A List of the previous issues in the customer's PC fed by previous runs of the Risk Calculation algorithm 135.

[203] A List of the previous tasks scheduled by previous runs of the Risk Calculation algorithm 135.

[204] A List of Rules grouped by the Scenarios where they could happen.

[205] A predefined process that evaluates each possible scenario.

[206] A predefined process that evaluates each rule in the scenario until reach one which his condition is true.

[207] A group of rules defined manually by the risk management team 403 and automatically by the risk detector 421.

[210] Before evaluate a rules a check is done to know if the rule has a pre-condition. It means if that the rule will be valid only if a previous issue has occurred.

[211] The rule interpreter get the values of the variables used in the rule to start the evaluation of the conditions. Such variables can be of several types between: S.M.A.R.T 212, Operative System 213, Backup 214, Antivirus 215, S.N.M.P 216, Hardware 217 or User Behavior 218.

[212] The S.M.A.R.T. variables are used to know the health of a hard disk. These variables belong to a technology originally developed for use with hard drives, and is described in SFF committee, Specification Self-Monitoring, Analysis and Reporting Technology, SFF-8035i, revision 2.0, Apr. 1, 1996.

[213] The Operating System variables are all kind of variables which can be extracted from an O.S. like CPU usage, Memory consumption, Operating System Version, File System Information, Drivers, Running services, Anti-virus, O.S. Firewalls, error logs etc.

[214] Backup variables are all the information related to the current state of the file backup process and its schedule. This backup module can be provided by the subject technology or by a third-party.

[215] The Antivirus variables correspond to brand, manufacturer, version, virus definition databases, events, alerts, scan results, etc.

[216] The SNMP variables are extracted from SNMP providers installed and running over customer's computers. These variables provide information regarding network traffic. Additionally, several Operating Systems offer their information through these variables such as NAS systems, firewalls, routers etc.

[217] The hardware variables refer to the computer's hardware features like the brand, model and serial number from the computer, memory module(s), processor(s), interface(s), motherboard etc. to know the user's hardware environment being able to calculate the risks involved using this combination of hardware and accessories.

[218] The user behavior variables refer to the good and bad handling of the computer like improper shutdowns, amount of time being mobile (on battery life), amount of new generated data rate and file types, to be able calculate risks involved 221, 222 and bring down the risks involved and to take proper actions 234.

[219] The rule conditions (expressions) could be single (only one variable, a comparison operator from <, >, <=, >=, = or !=, and a value to compare) or multiple (a couple of single expressions linked by a logic operator AND or OR).

[220] The single expression interpreter takes the value of a variable and compare it with the predefined value, applying a comparison operation.

[221] The multi expression interpreter takes the result of the left and right expressions evaluated by a logic operation (AND or OR).

[222] The left expression is evaluated first and the result is returned to the multi expression interpreter.

[223] The right expression is evaluated after the left one and the result is returned to the multi expression interpreter.

[224] If the rule expression evaluated returns true the issue is registered and the risk level is extracted from the rule to be compared with the current maximum.

[225] If the rule issue do not exist in the current list of issues the algorithm continues with the next rule.

[226] If the rule issue already exist in the current list of issues the existing issues are deactivated, what means that are took out from the list for next iterations of the algorithm.

[227] If the conditions of the rule are true the risk level of the rule 136 will be analyzed.

[228] If the conditions of the rule are true a new issue will be registered in the list of current issues.

[229] Check if the risk level of the rule is higher than the current maximum.

[230] Update the current maximum risk found between the rules analyzed that returned true.

[231] Depending on the rule a list of actions will be added to the list of tasks to execute in order to try to solve the problem.

[232] A group of actions which are executed or not depending on the rules result. These actions are executed in order to eliminate or decrease the risk of data loss.

[233] The algorithm continues until all the scenarios were evaluated.

[234] A predefined process which executes a group of actions in order to bring the risk level to green.

[235] A predefined process which looks for the highest risk level result within the rules result and sets this level as new risk level of data loss.

[236] A predefined process which compares the last risk level and the current risk level. If an improvement on the risk level was found, a high score will be assigned to the rules and actions that were executed during this period.

[237] A predefined process which stores the information extracted by the previous process 236 in a database in order to create a ranking of the most effective rules and actions of the AIRC risk management system.

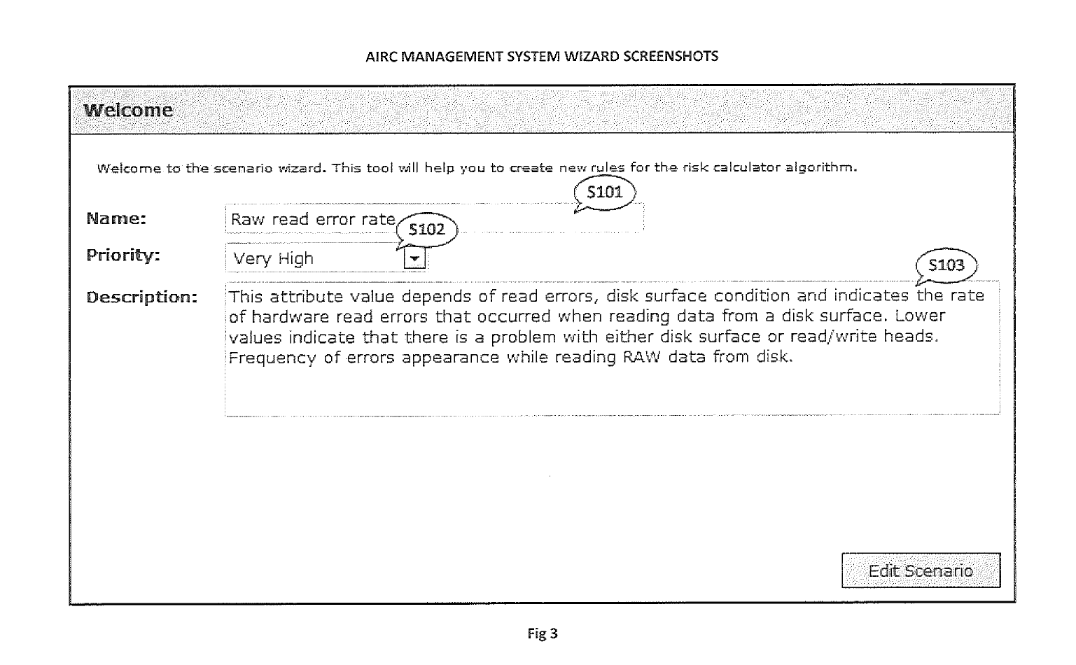

### FIG. 3

[S101] Shows a screenshot area where a new scenario title can be provided.

[S102] Shows a screenshot area where a selection list to set the priority of the scenario is.

[S103] Shows a screenshot area where the scenario description can be provided.

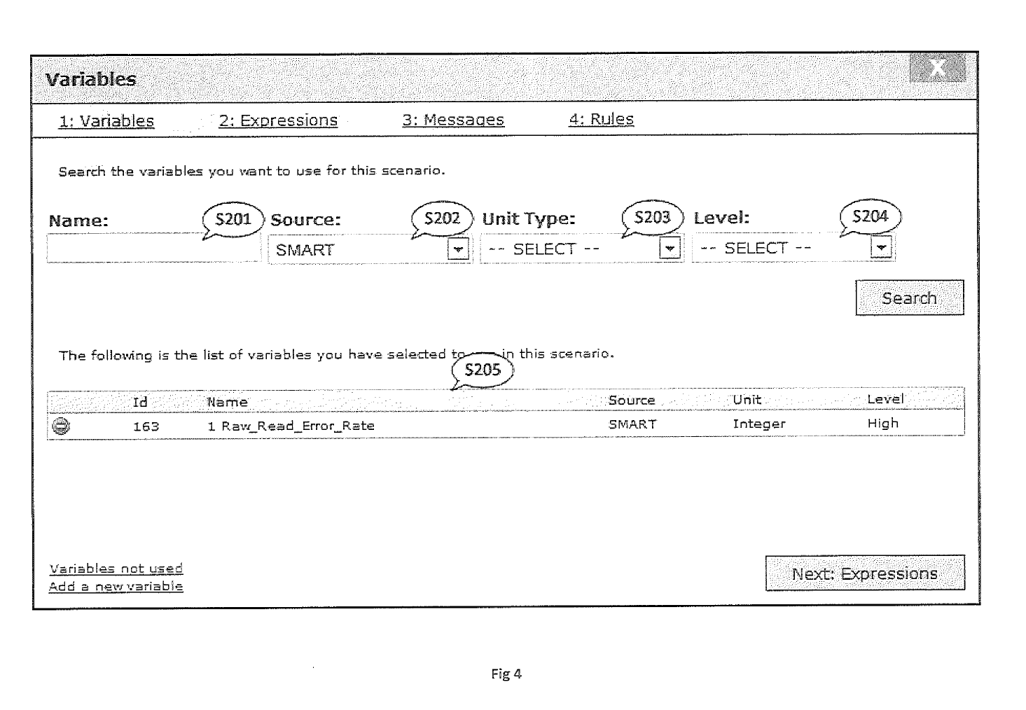

### FIG. 4

[S201] Shows a screenshot area where a name can be written as a criterion for the variables search.

[S202] Shows a screenshot area where a source type can be selected as a criterion for the variables search.

[S203] Shows a screenshot area where a unit type can be selected as a criterion for the variables search.

[S204] Shows a screenshot area where a level can be selected as a criterion for the variables search.

[S205] Shows a screenshot area where the list of selected variables for the scenario is.

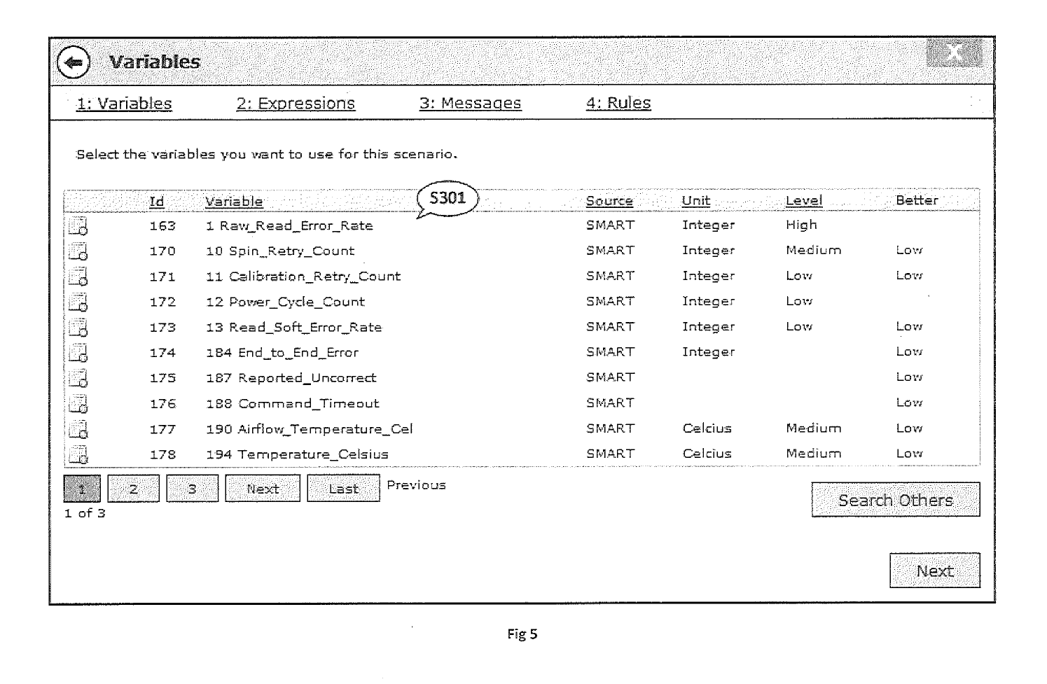

### FIG. 5

[S301] Shows a screenshot area where the list of results of the variables search is.

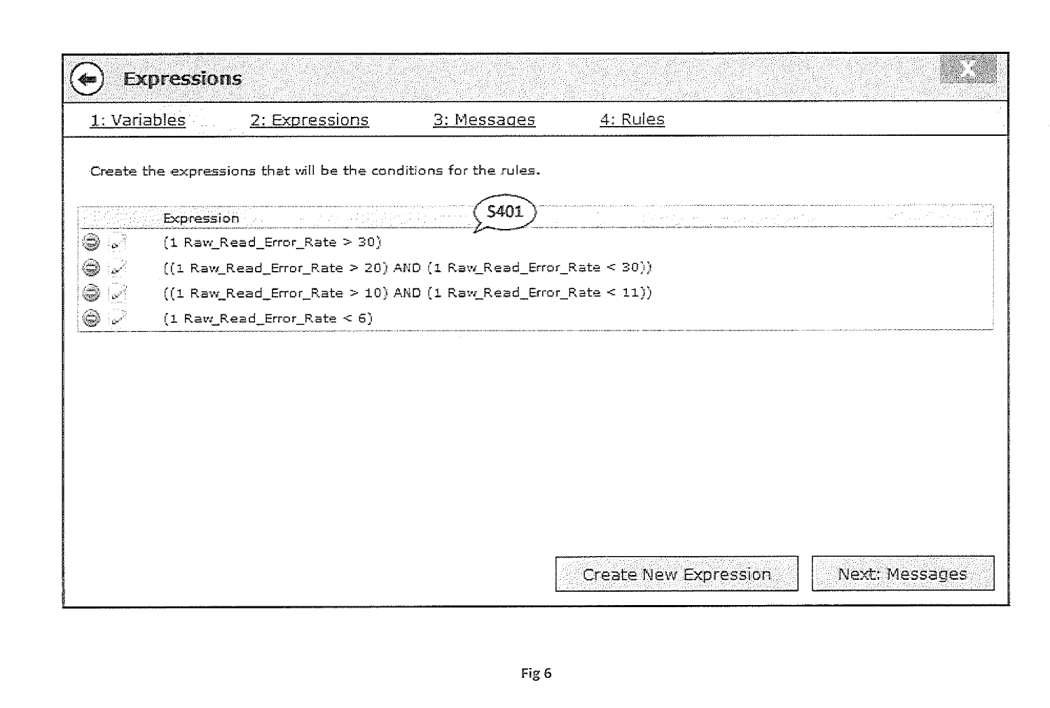

### FIG. 6

[S401] Shows a screenshot area where the list of the current expressions created for the scenario is.

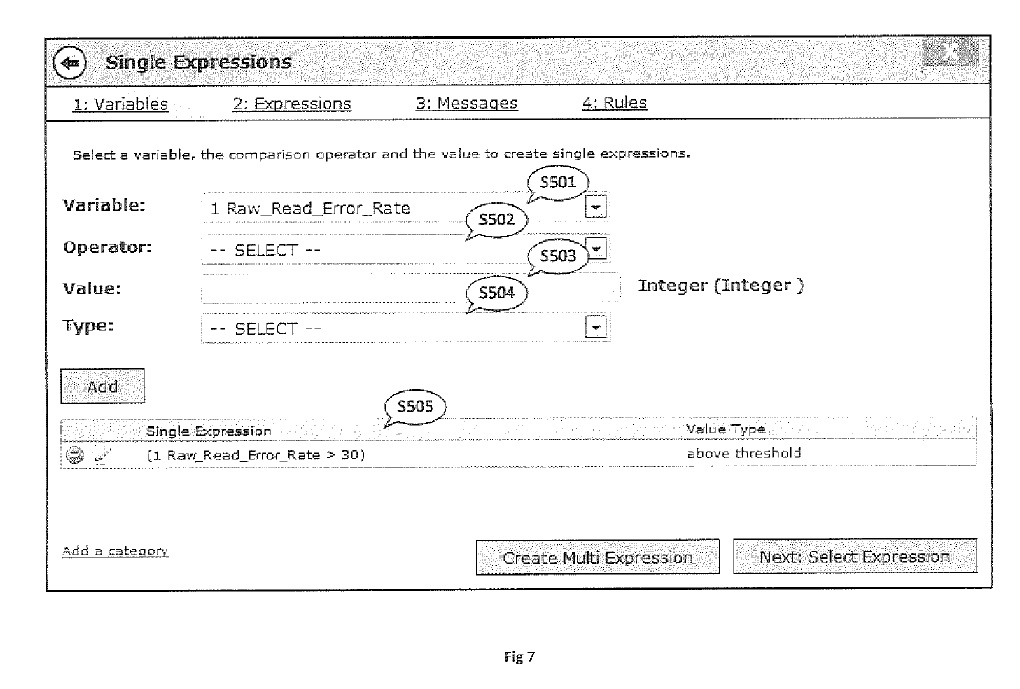

### FIG. 7

[S501] Shows a screenshot area where a variable can be selected for single expression creation.

[S502] Shows a screenshot area where an operator can be selected for single expression creation.

[S503] Shows a screenshot area where a value can be set for single expression creation.

[S504] Shows a screenshot area where a type of value can be selected for single expression creation (it will appear if the variable can have several kind of values, e.g. S.M.A.R.T variables).

[S505] Shows a screenshot area where the list of the current single expressions created for the scenario is.

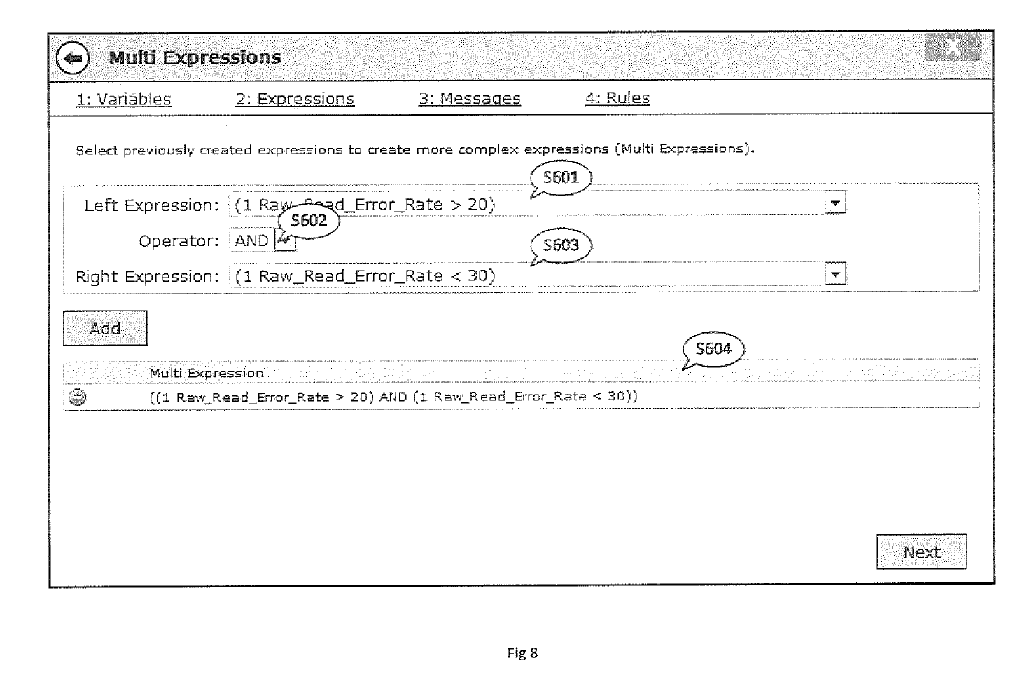

### FIG. 8

[S601] Shows a screenshot area where a single expression can be selected as left expression for multi expression creation.

[S602] Shows a screenshot area where a operator can be selected for multi expression creation.

[S603] Shows a screenshot area where a single expression can be selected as right expression for multi expression creation.

[S604] Shows a screenshot area where the list of the current multi expressions created for the scenario is.

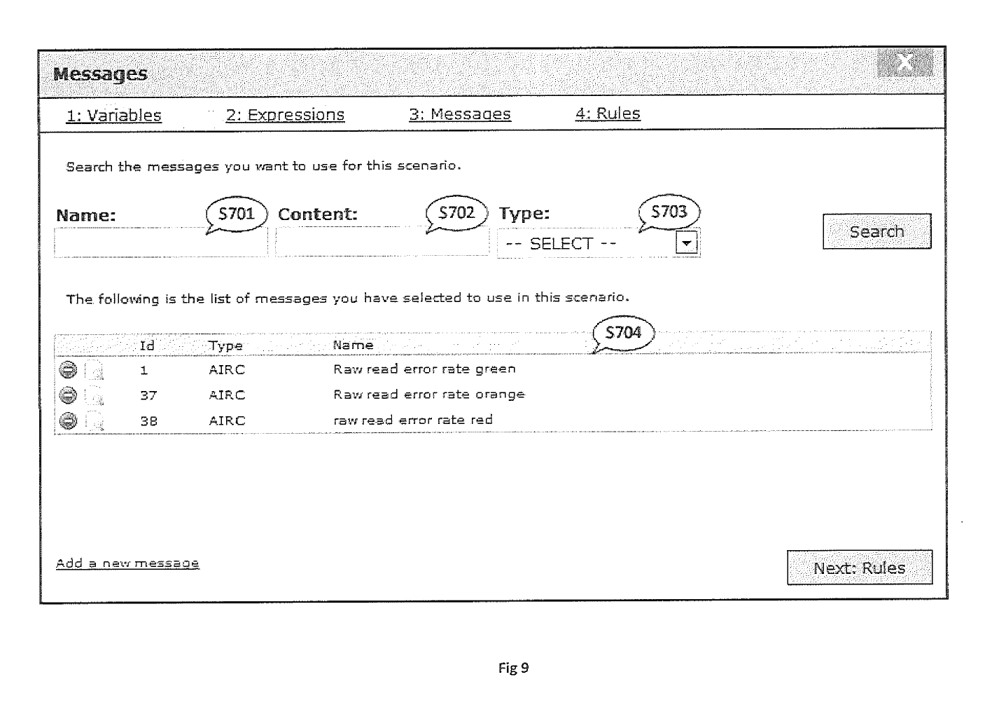

### FIG. 9

[S701] Shows a screenshot area where a word can be written as a criterion for the message search by name.

[S702] Shows a screenshot area where some words can be written as a criterion for the message search by content.

[S703] Shows a screenshot area where a type of message can be selected as a criterion for the message search.

[S704] Shows a screenshot area where the list of the current messages selected for the scenario is.

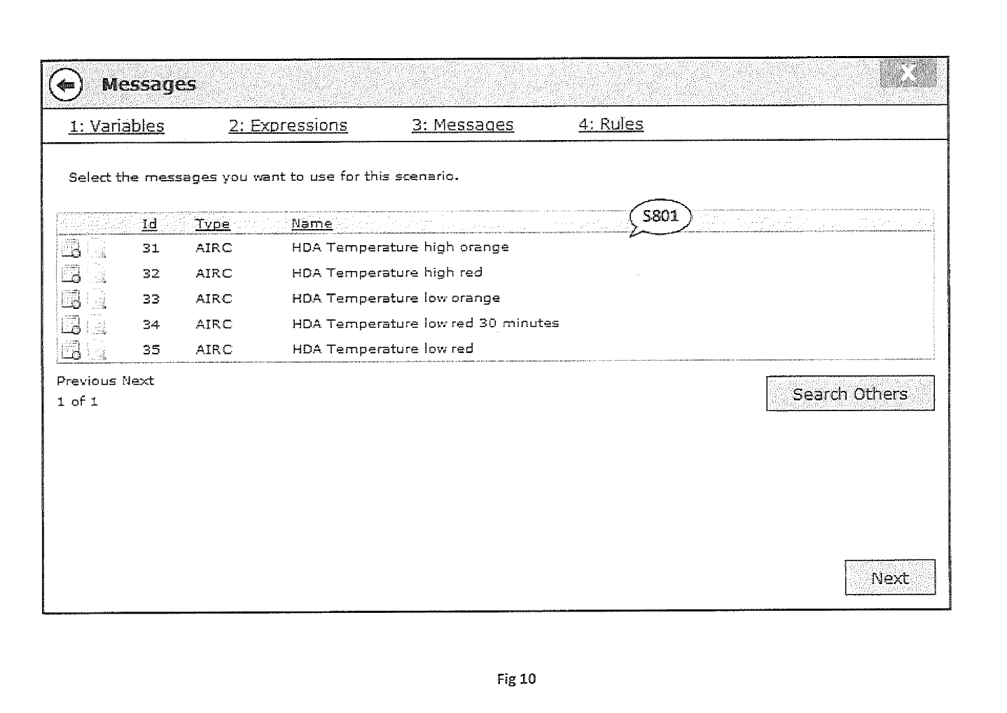

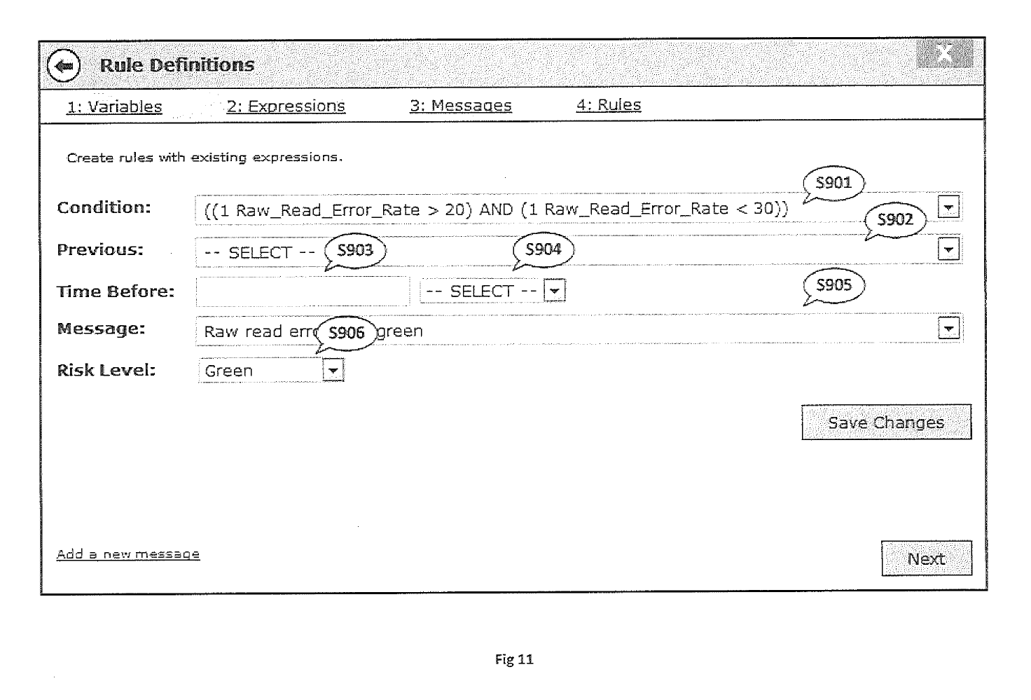

### FIG. 10

[S801] Shows a screenshot area where the list of results of the message search is.

[S801] Shows a screenshot area where the list of results of the message search is.

### FIG. 11

[S901] Shows a screenshot area where an expression can be selected as condition for a rule creation.

[S902] Shows a screenshot area where an expression can be selected as previous condition for a rule creation. (This field is optional).

[S903] Shows a screenshot area where a number can be provided as amount of time after the previous condition. (This field is optional).

[S904] Shows a screenshot area where a unit (hours, minutes or seconds) can be selected for the amount of time after the previous condition. (This field is optional).

[S905] Shows a screenshot area where a message can be selected as the message to be shown to the user in case that the condition will be true. (This field is optional).

[S905] Shows a screenshot area where a risk level can be selected as the risk level to be set in the client application in case that the condition will be true. (This field is optional).

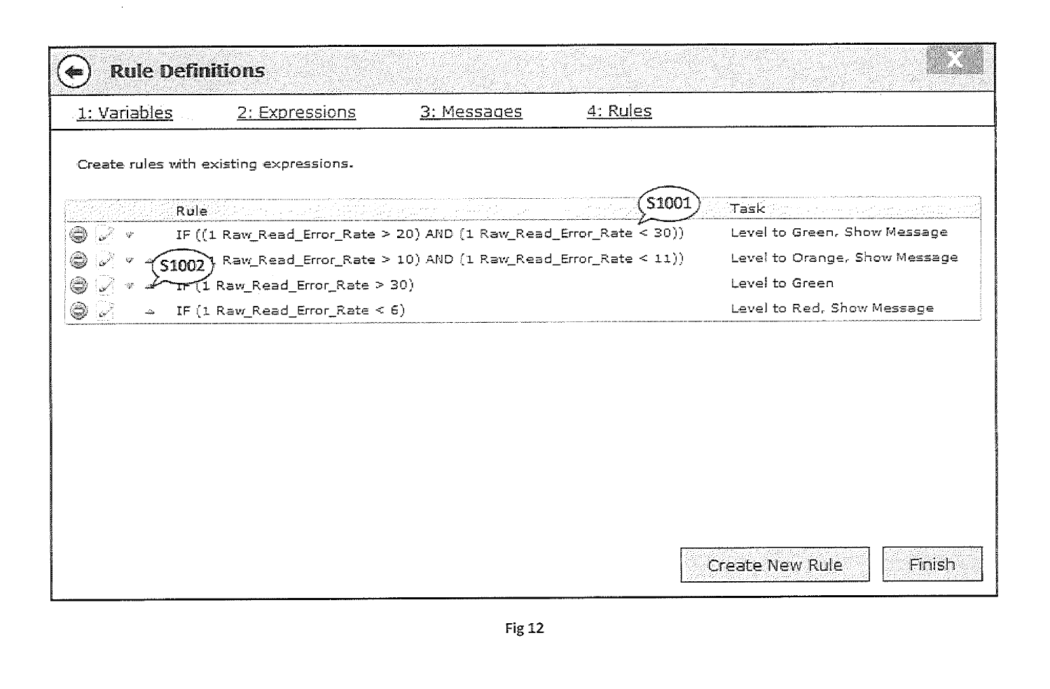

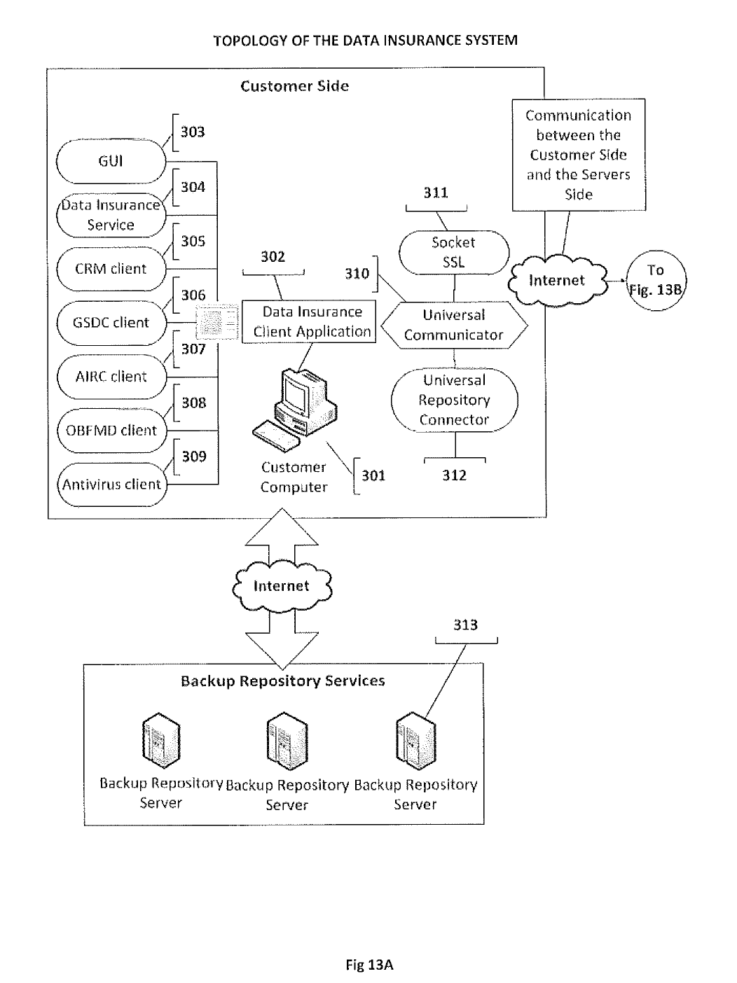

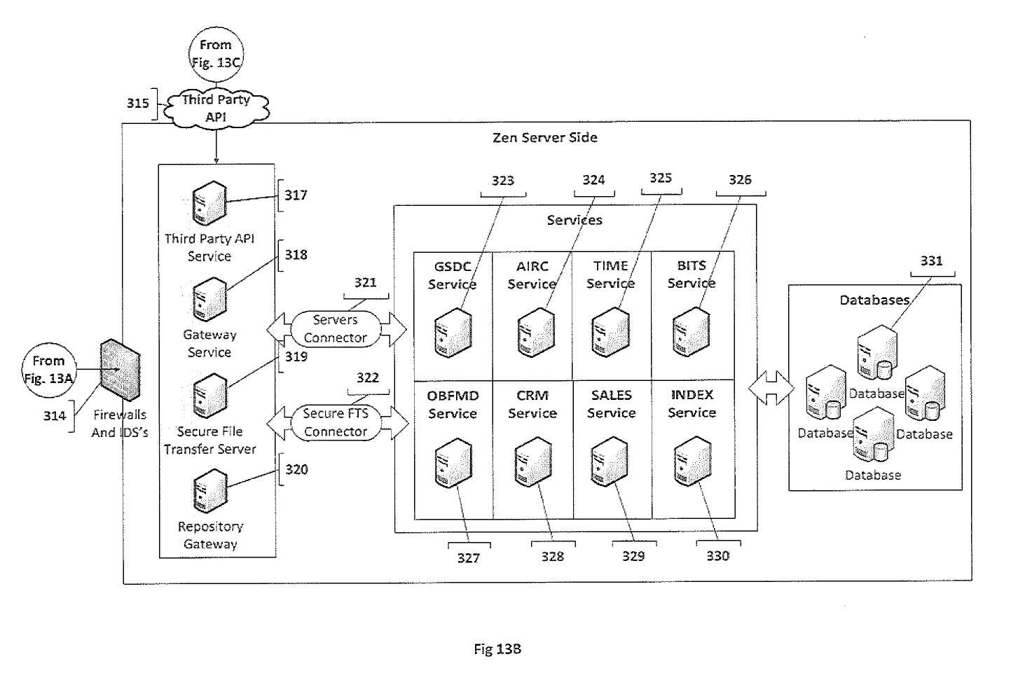

### FIG. 12

[S1001] Shows a screenshot area where the list of current rules created for this scenario is.

[S1002] Shows a screenshot area where are arrow controls to set the priority of each rule.

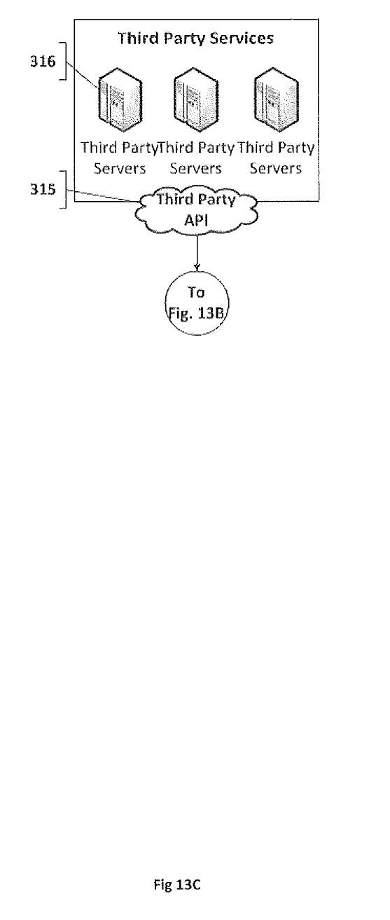

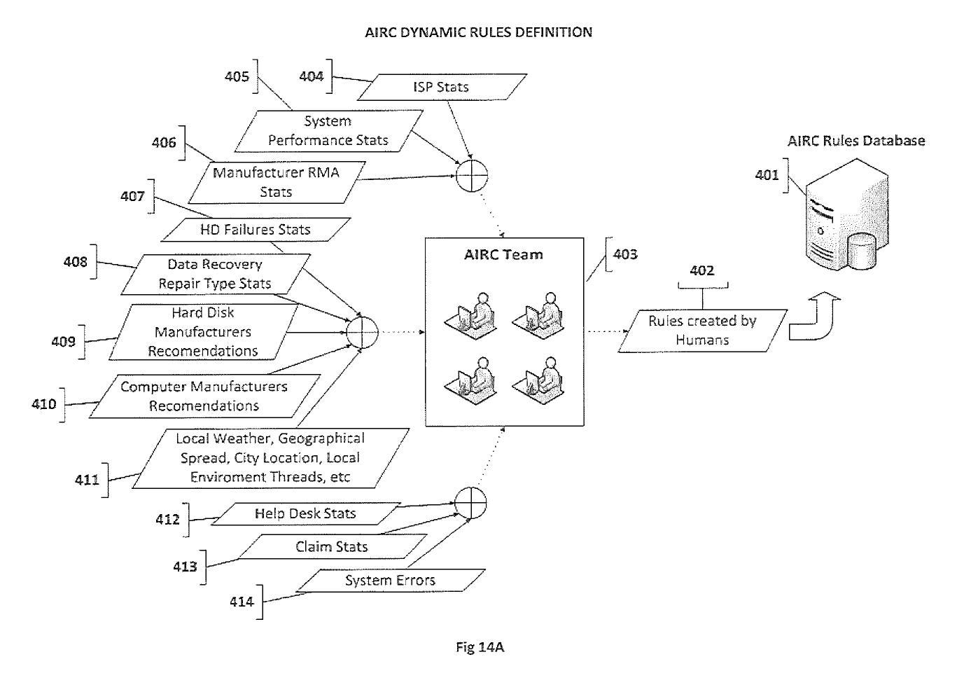

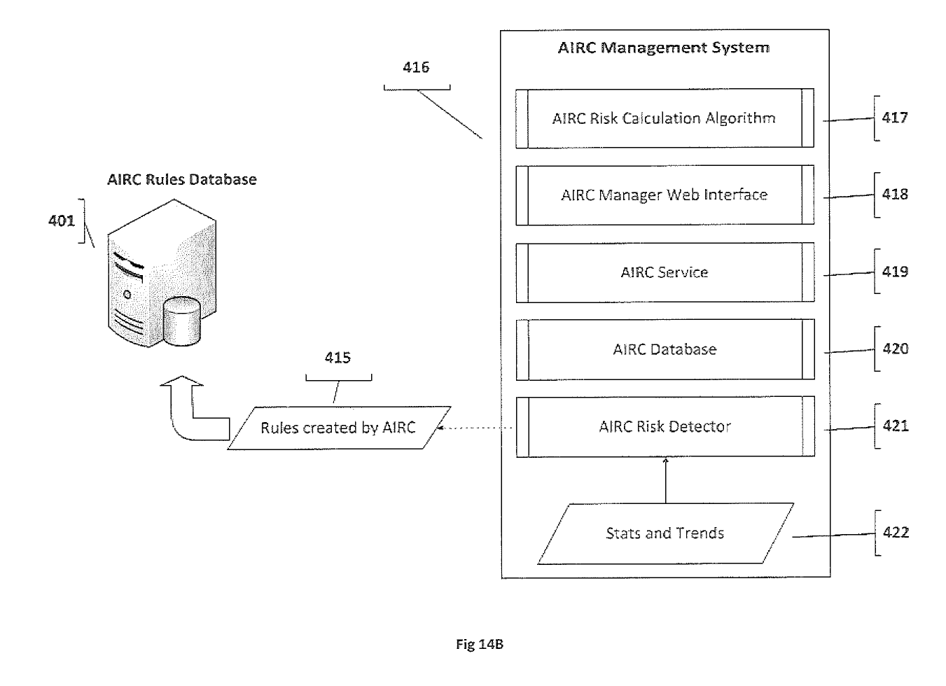

### FIGS. 13A-C

[304] The data insurance service is a daemon or system service which runs in background at the customer's computer.

[303] The graphical user interface for the data insurance service 304.

[305] The CRM client is in charge of performing all the functionalities regarding customer relationship management.

[301] Customer's PC where it runs the Data Insurance Client Application 302.

[302] Application that uses all the modules 303, 304, 305, 306, 307, 308 and 309 for the data insurance service.

[303] Graphical user interface of the application.

[304] Service of data insurance in case that the user had a paid license for his storage media.

[305] The CRM client is in charge of the authentication of the users, customer support and the licensing process.

[306] The GSDC client is in charge of extracting all the customer's computer variables.

[307] The AIRC client is in charge of managing the risk of data loss at the client side. It is very important because with this module the Data Insurance Service is able to keep calculating the risk and executing actions when the application is offline.

[308] The OBFMD client is in charge of implementing the file tracking and file backup for the Data Insurance Service and is able to integrate to a third-party backup solution.

[309] The Antivirus client is in charge of elimination, cleaning, and report of threats of malicious codes in the user's files.

[310] The Universal Connector is a module of the Data Insurance client application 101 which allows connecting every kind of service application offered through the network, including the services located at the server side of the subject technology.

[311] A SSL Socket is created by the Universal Connector in order to connect the customer side and the server side of the subject technology through an encrypted channel.

[312] The Universal Repository connector is a module of the Data Insurance Client application which is able to connect every kind of data repository provider through the Internet.

[313] The Backup Repository Service is offered in order to store and recover data through a network channel which can be Internet or a private channel. These Backup Repository Services can have several datacenters in different cities, countries or continents 313a, 313b, 313c.

[314] Firewall and IDs to protect the internal network from possible intruders.

[315] Third party API to call remote procedures of third party allies.

[316] [317] The third-party services can be insurance companies, online backup providers, anti-virus software partners, banks, and anyone else who wants to offer data insurance can connect to the subject technology through the Third-party API to integrate the subject technology in their services.

[318] The Gateway service is in charge of receiving all the connections from the Data Insurance Client applications. This service acts like a bridge by interconnecting the Data Insurance Applications with the services located at the MZ (militarized zone).

[319] The Secure File Transfer server is used for the file transfers between client application and the services servers using a proprietary protocol over an encrypted channel.

[321] The Servers connector is a module which allows connecting all the services located at the MZ.

[322] The Secure FTS connector uses our secure proprietary protocol to transfer the files.

[323] The GSDC service is in charge of collecting all the customer computer variables.

[324] The AIRC service is in charge of managing the risk of the entire customer insured data.

[325] The TIME service is in charge of synchronize the time between servers.

[326] The BITS service is in charge of the update file transfers of the client application.

[327]The OBFMD service is in charge of managing all the backup information and file tracking for the data insurance service.

[328] The CRM service is in charge of managing all the customer resources like account creation, customer reports, etc.

[329] The SALES service is in charge of managing all the customer resources like payments, licenses, etc.

[330] The INDEX service is in charge of tracking where the information belonging to a customer is located inside the distributed database system. This service is very important for load balancing.

[331] A database server which stores part of the database, which is distributed.

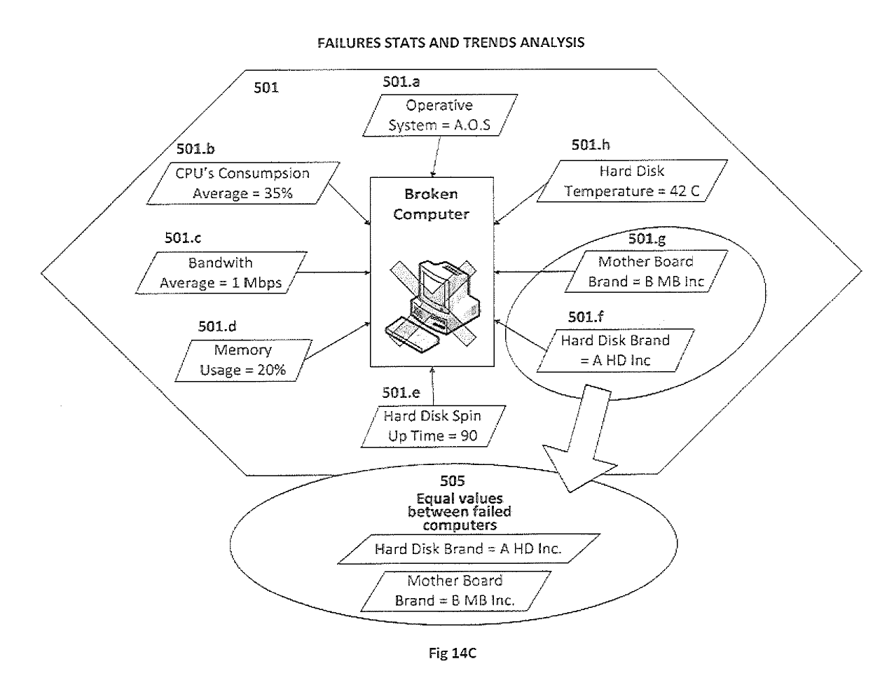

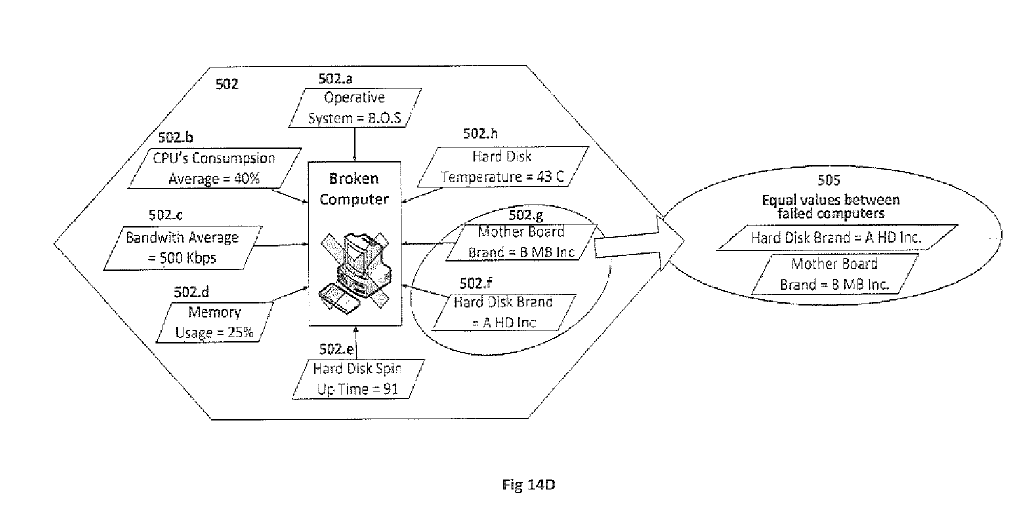

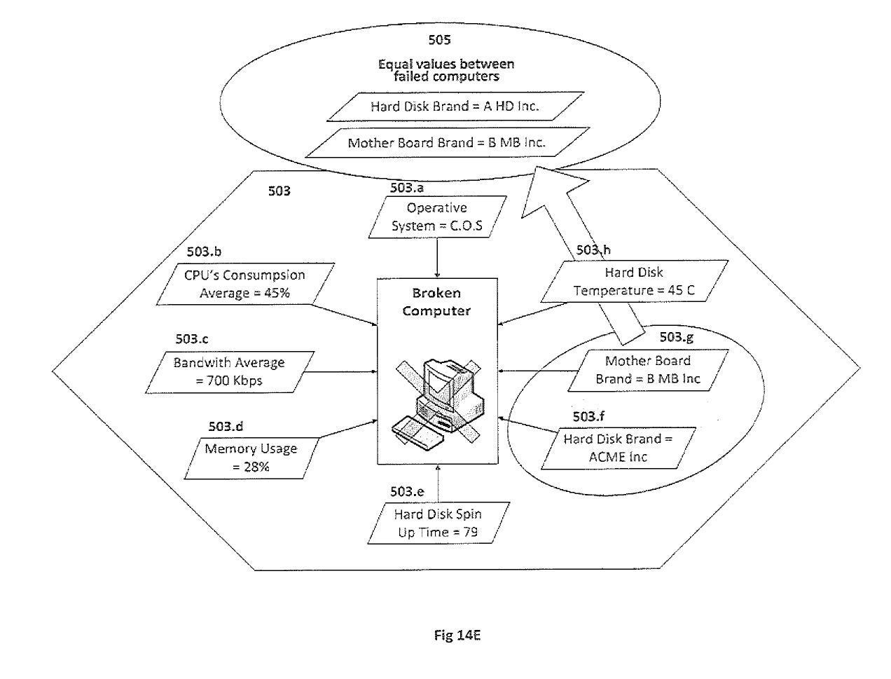

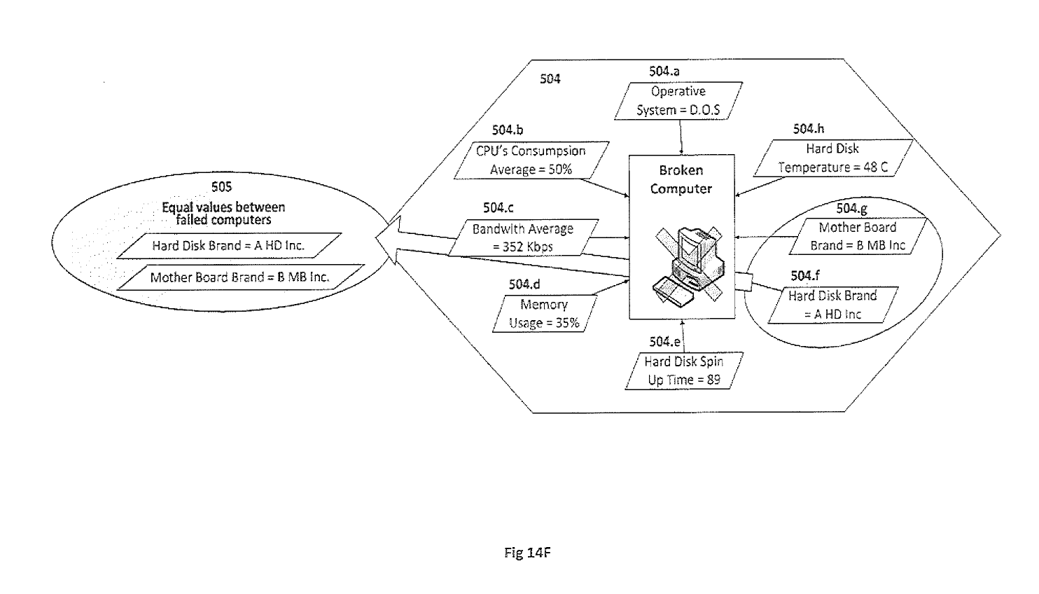

### FIGS. 14A and 14B

[401] A database on which the rules defined by the AIRC team and the Risk Detector are stored.

[402] Single rules and multi rules created by the AIRC team.

[403] A team of human resources which is in charge of analyzing the risk of data loss and the creation of rules and actions that are added to the risk calculation algorithm in order to decrease the risk.

[404] In order to know the Internet conditions of the local providers near to a customer, the ISP stats are taken into account for creating the rules of the AIRC risk management system. ISP/Telecom alliance partners can host data repository provider(s) and/or be one to take the advantage in cost reduction using their own virtual and/or optical fiber networks.

[405] The system performance stats are extracted from the Operating Systems or directly from sensors. This can be done using OS specific protocols like WMI on Windows or generic protocols like SNMP.

[406] The manufacturer RMA (return merchandise Authorization) stats are all the data collected from a manufacturer that have a transaction whereby the recipient of a product arranges to return goods to the supplier to have the product repaired or replaced or in order to receive a refund or credit for another product from the same retailer.

[407] This stats show all the events of failures detected from hard disks.

[408] This stats will show the different types of data recoveries made by the data recovery laboratory service.

[409] The hard disk manufactures publish documents with recommendations for the use of their devices. This information is used as input by the AIRC team.

[410] The computer manufactures publish documents with recommendations for the use of their devices. This information is used as input by the AIRC team.

[411] External factors of the computer are taken in account like the geographical location of a customer and the weather conditions on that area.

[412] The stats collected by the Helpdesk are passed as input to the AIRC team.

[413] The claim stats are extracted from pending, accepted and denied customer claim cases.

[414] The system errors can be extracted from the customer computer O.S. logs, SNMP logs and other variables.

[415] Single rules and multi rules automatically created by the AIRC Risk detector.

[416] The AIRC Management system is in charge of decreasing or avoiding the risk of data loss of all the customer's insured data. This system is composed of a Risk calculation algorithm, an AIRC database, a Risk detector, a Web interface and a service 138 to offer functionalities through the network.

[417] This AIRC risk calculation algorithm is used to define the risk level (Green, Orange, Red) of data loss, the duration of this risk level and the actions needed to prevent the risk.

[418] A web interface used by the AIRC team in order to create single rules and multi rules.

[419] A Service application which offers functionalities belonging to risk management through the network.

[420] A data collection which contains all the information needed to fulfill all the risk management tasks.

[421] The AIRC Risk detector is in charge of analyzing failure stats and trends in order to detect new risks of data loss and to create new rules and actions that help in avoiding or decreasing risks.

[422] Stats from the broken computers.

### FIGS. 14C-F

[501] [502] [503] [504] These are different failing computers which present similar problems with the bootup. Before this problem appeared, the Data Insurance Client application 101 was extracting computer's variables from them. The variables (a, b, c, d, e, f, g of FIG. 12) taken into account in this example are Operating System, CPU usage and Bandwidth Average.

[505] These are the equal values between the computer variables among the failing computers 501 502 503 504 in FIG. 12.

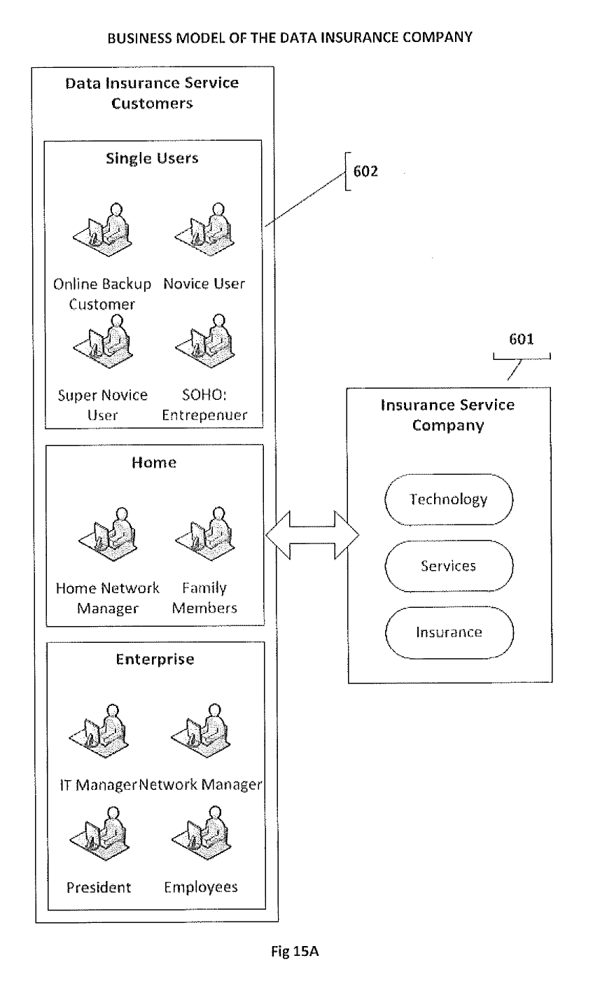

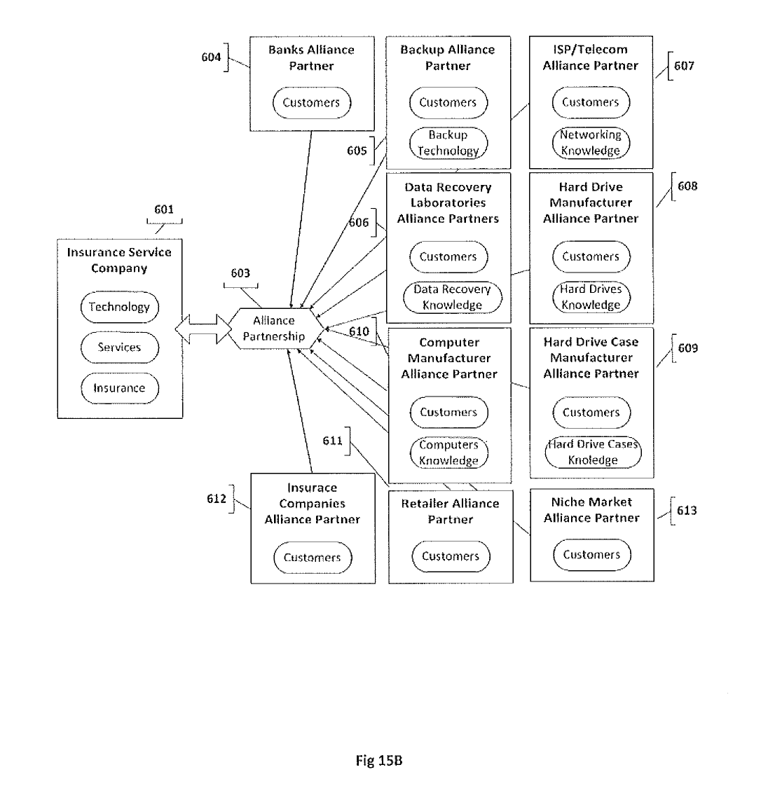

### FIGS. 15A and 15B

[601] The Insurance Service Company will make use of advanced technology approaches and knowledge to reduce the risks of data loss by giving to the customers several services.

[602] The insurance services could be sold to any kind of customers since novice pc users to expert users. It will be sell individually or for groups. The hierarchy of usage options and permissions will depend on the group.

[603] The company will make alliance with different kind of partners in order to get more customers and exchange knowledge that would be useful for every party. For example, the insurance company will recollect statistics about possible scenarios that cause damages in a kind of hard drives. In exchange the hard drive company would give knowledge useful to create new rules.

[604] Banks would be a kind of possible alliance partners which would offer the insurance services in their portfolio.

[605] Backup companies would be a kind of possible alliance partners which would work as one of the backup repository provider.

[606] Data recovery companies would be a kind of possible alliance partners which would work as one of the assistance centers to recover data from broken hard disks.

8 607] ISP/Telecom companies would be a kind of possible alliance partners which would offer the insurance services in their portfolio.

[608] Hard drive companies would be a kind of possible alliance partners which would offer the insurance services with an OEM license.

[609] Hard drive case companies would be a kind of possible alliance partners which would offer the insurance services with an OEM license.

[610] Computer companies would be a kind of possible alliance partners which would offer the insurance services with an OEM license.

[611] Retailers would be a kind of possible alliance partners which would offer the insurance services in their portfolio.

[612] Insurance companies would be a kind of possible alliance partners which would offer the insurance services in their portfolio.

[613] Niche market companies would be a kind of possible alliance partners which would offer the insurance services in their portfolio.

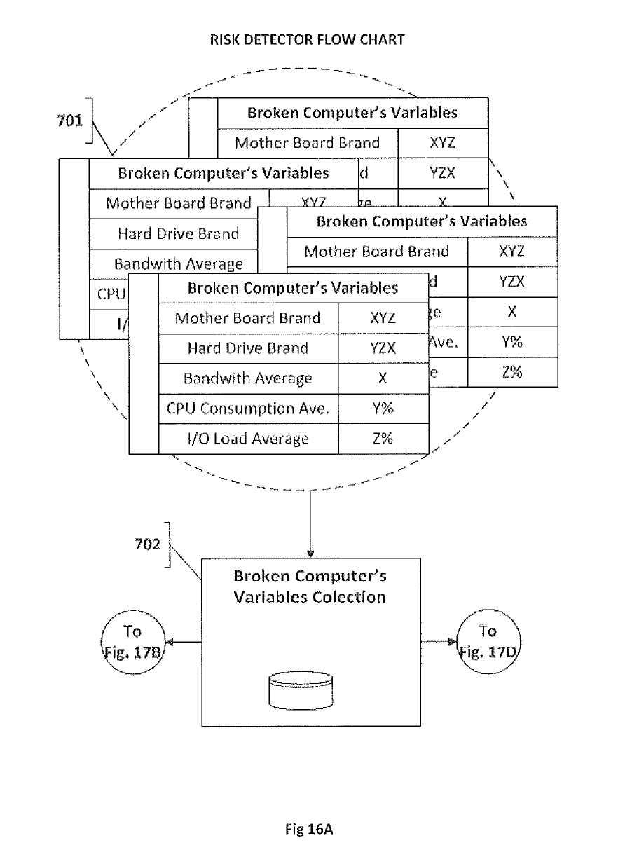

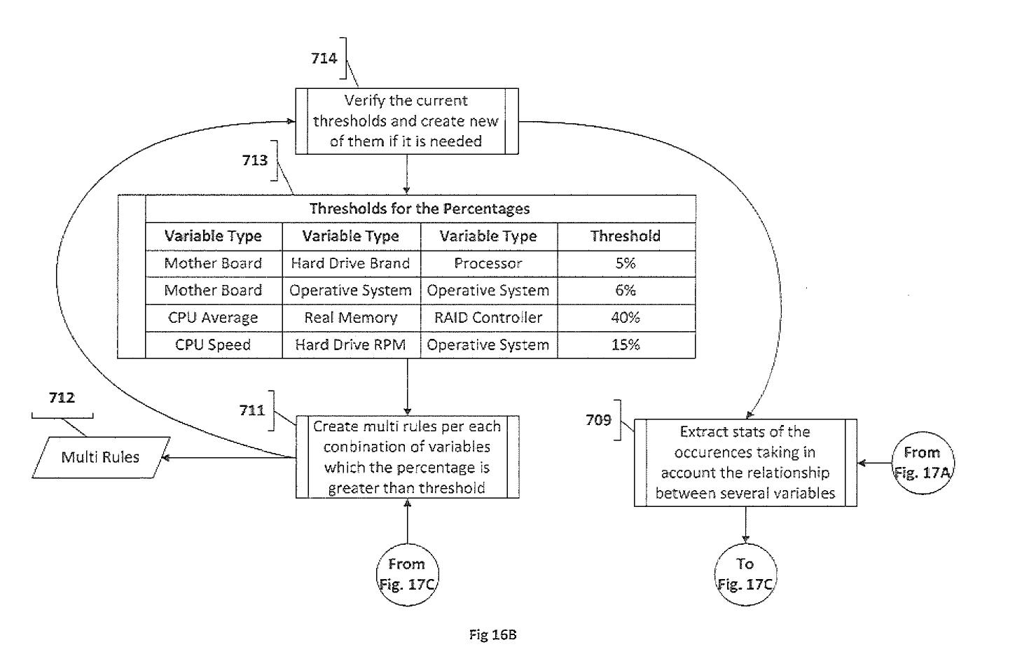

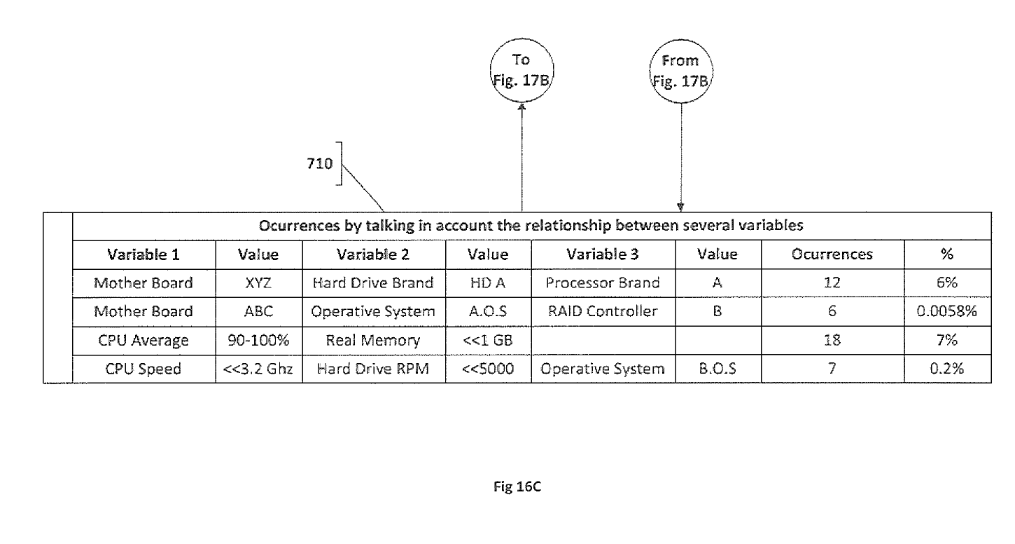

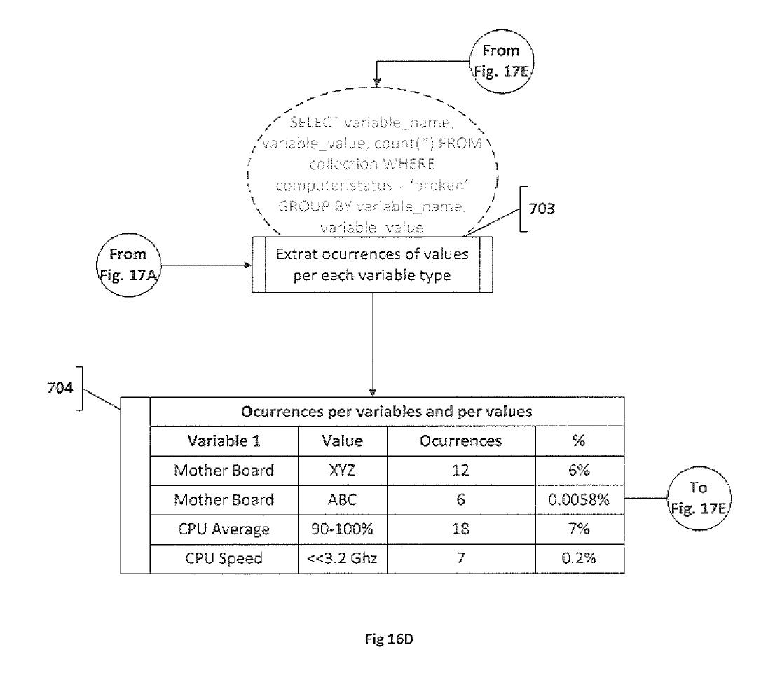

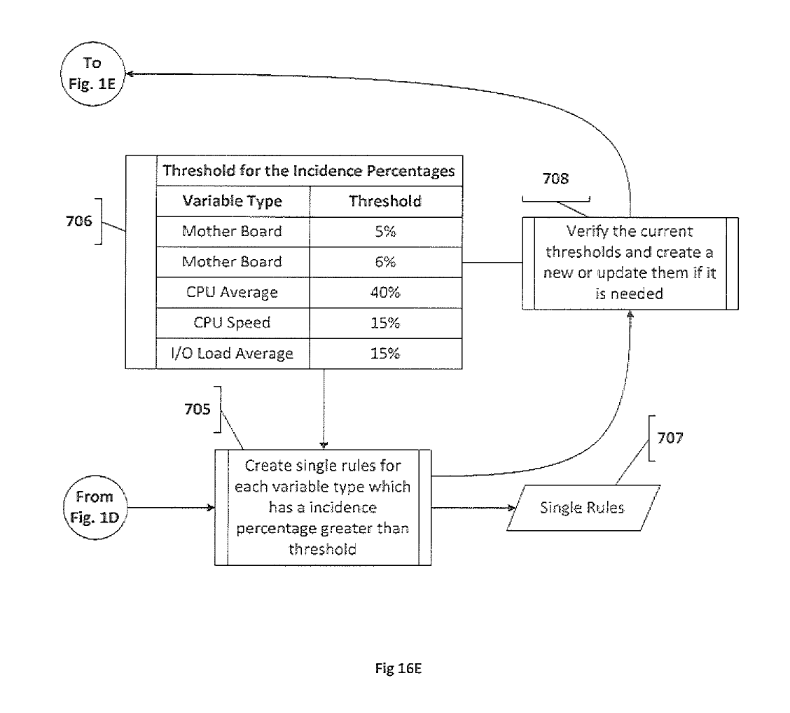

### FIGS. 16A-D

[701] These are the groups of variables extracted from the broken computers before they were out of order.

[702] This is a data collection or database for all the computer's variables 701 extracted from broken computers1.

[703] A predefined process which takes the data stored into the collection 702 and extracts the occurrences of equal values per each variable type in order to create stats for the values which more often appears at the collection stats.

[704] This is the result from the extraction process described at 703, this table contains a first column called “Variable” for all the variable types, the next column called “Value” is for the different possible values of the variable type, the next column called “Occurrences” shows the number of occurrences of the value, and the last column called “Percentage” shows the percentage of hardware devices from the total population belonging to this hardware type.

[705] A predefined process which creates singles rules taking in account the table result described at 704 and a table which contains Thresholds 706 for the percentages. For each percentage which is greater than its threshold then a single rule will be defined in order to cover this risk which belongs to the variable type.

[706] A thresholds table which contains the maximum percentage values for each variable type.

[707] All the single rules created by the Risk Detector after the process described at 705.

[708] A predefined process which verify if the current thresholds are effective or not and update them if is needed.

[709] A predefined process which creates stats for the occurrences by taking in account the relationships with several computer variables.

[710] This is the result from the process described at 709, this is a table which contains N couples of columns, the first column of the couple is called “Variable” for all the variable types, the next column of the couple is called “Value” and contains all the different possible values of the variable. After all the N couples of Variable-Value the next column called “Occurrences” shows the number of occurrences of the this Variable-Value combination, and the last column called “Percentage” shows the percentage of this Variable-Value combination from the total population which has this Variable-Value combination.

[711] A predefined process which creates multi rules taking in account each variable of the combination presented by the table described at 710 and the thresholds contained at the table described at 713.

[712] A group of multi rules created by the Risk Detector.

[713] A thresholds table which contains the maximum percentage values for each combination of variable-values.

[714] A predefined process which verify if the current thresholds are effective or not and update them if is needed.

### Definitions for the Subject Technology

Below is a list of terms and, without limitation, associated definitions to assist readers with the subject technology.

Insurance Coverage: What is covered by the insurance policy. This deferrers depending risk level and selected insurance policy.

Dynamic Risk Management: is the action of calculating, monitoring, controlling, decreasing and avoiding the risk of data loss based on criteria defined by rules, which are created on demand depending on the technological needs of the moment to decrease the thread of data loss.

Risk calculation algorithm: is a finite sequence of instructions, an explicit, step-by-step procedure for solving the problem used for processing the variables and calculate the risk of data.

Risk calculation result: is the combination of the resulting risk level which can be green, orange or red; and the duration of said risk level. It is an outcome of an executed calculation with the risk calculation algorithm.

Trends: When a series of measurable events keep a close relationship to each other a trend is detected.

Specialized Laboratory: it refers to a laboratory and/or clean room with a team of specialists that attempt to recover data stored on a broken hard disk by using specialized tools and methods applied directly to the disk or an low level image of the hard disk.

Non-volatile memory: memory that can retain the stored information even when not powered. Examples of non-volatile memory include read-only memory, flash memory, most types of magnetic computer storage devices (e.g. hard disks, SSD drives, floppy disks, and magnetic tape), and optical discs.

OS: Operating System.

Personal firewall: OS default firewall that comes embedded when with the OS.

Referring again to FIGS. 1A-F, it is described how the Data Insurance Client Application works. The subject technology is composed by a Client Application which has a system service or daemon 101 running at the customer's computer 102. This system service or daemon 101 starts before the customer logs on and its execution continues for all the time the computer is on.

The first step of the work-flow is to identify the computer by using the unique data per customer stored at the server's side of the subject technology 108. The hard disk information and the serial number of the mother board are extracted at step 103 in order to identify whether the customer is logged on his machine or not, and additional username and password comparisons are performed. This information is sent through the Universal Connector 107 to the CRM service 108 of the Data Insurance Client Application.

The CRM service 108 is in charge of managing all the customer information related to his identity: user account, user resources and logon process. The Universal Connector 107 is a library designed and developed within the subject technology, which is able to connect any kind of network destination and to create any kind of network listener for several protocols such as TCP, UDP, REST, RESTFUL, HTTP, FTP, SOAP or JSON.

When the CRM service 108 receives the customer's login information, all this data 104 105 106 is matched against the information stored in the CRM's database. A login process result 109 is then generated and received by the Universal Connector 107, which in turn passed it to the Login Process 110 at the Data Insurance Service 101. The Login Process 110 will evaluate whether the login process was successful or not 110a. In case the login has not been completed successfully, the login process shows a message to the customer and the process is repeated by asking new values for the inputs. In case the login process was successful, the data insurance service is enabled 111. This data insurance service will work with three insurance coverage levels represented by the colors: Red, Orange and Green. Red means that the customer is not insured as result of high risk of data loss. This condition may be caused by not following the instructions and recommendations made by the Data Insurance Client application 101. Orange means the customer data insurance is limited to a data recovery attempt in a specialized laboratory, and Green means that in case of data loss the data insurance service will make a payment to compensate unexpected data loss.

The Data Insurance Client Application 101 implements an ongoing or infinite loop which is constantly listening for events generated by a Timer 114. The Timer notifies the data insurance client application 101 when to calculate the risk, when to verify the backup status or when to extract the customer's computer variables, this is, the Timer 114 works as a task scheduler that can be configured remotely by the AIRC team at the server side 168. Events generated by the Timer 114 wake the Data Insurance Client Application up in order to realize some tasks. These events are defined by an event table 113, whose rows specify an event code, type, description and an action. An example of a event table row can be: code=001/type=GSDC Event/actions=Extract SMART variables. When this event is emitted, the Data Insurance Client application 101 will start the SMART variables extraction process.

Returning to FIG. 2, after a new event 115 is generated by the Timer 114 the event type processor 116 defines the next group of instructions which will be executed based on the event's type. The first instruction set corresponds to AIRC events. For any AIRC event the first step to follow is to know whether the AIRC risk calculation rules 207 are up to date or not by getting the current rule version 117.

If the rules are not updated 117a, a process to update them is initiated 118 and, through the Universal Connector 107, a request 119 is sent using a communications protocol. The AIRC Service 138, which is in charge of implementing the risk management of data loss for all the customers, sends the last version of the rules 120 to the “Update Rules” process 118, and then, when the AIRC rules are up to date 117a, the risk calculation is executed 135 by the AIRC algorithm FIG. 2. This calculation is executed by using the latest version of the customer variables 146 as input, which includes S.M.A.R.T variables, Operating System Variables, movement sensor variables, insured files backup variables, Anti-virus Variables, S.N.M.P. variables, Hardware variables, and user behavior variables.

When the risk calculation is done 135 a new risk level 136 is obtained. This level is sent to the AIRC service 138 to be verified and approved. In order to avoid any possibility of fraud, the risk level is recalculated 139 by the AIRC service and then is compared with the risk level generated by the Data Insurance Client Application 101 installed on the customer machine. If both risk levels are equal, the service sets the new risk level for the customer computer 143. Otherwise, there is a high probability that the service rules are not updated and therefore the rules version is verified again. In case the last verification fails, a possible fraud case has been found. In case the new level cannot be sent to the AIRC Service 138 due to not being connected to the network, the Client application 101 will compare the calculations once the network connection is restored. Meanwhile the new risk level will be shown based on the calculation done at the client application 101.

In case the event type processor 116 classifies the event 115 as of GSDC type, the customer variable extraction process 121 is executed and the last version of these variables is stored at the data insurance service 101 and sent to the GSDC service 123 in order to set up the data for the next risk calculation 135.

In case the event type processor 116 classifies the new event 115 as of OBFMD type, the next step 124 is to verify whether the files selected to be backed up have been modified or not. At step 124a, the Data Insurance Client Application determines if any files have changed. If no files were changed, the OBFMD event does not cause any activity to be executed. On other hand, this is where some of the files were modified or have not been backed up yet, the OBFMD client at the insurance service detects 125 the blocks 126 of each file which have been modified and are then sent to several backup repository destinations 128 with the help of the Universal Repository Connector 127. Additionally, the subject technology has the capability to be integrated with third-party backup providers like Mozy of Seattle, Wash. at www.mozy.com in order to delegate backup functionalities or simply to have backup redundancy.

It is important to note that in order to calculate the risk of data loss in an effective way the subject technology should know the computer status and its environment and therefore, the subject technology will collect related information that will be used for risk management purposes only.

Referring now to FIGS. 2A-E, the risk calculation algorithm is described. The algorithm works for both client and server side. Note that any module of the system in charge of calculating the risk of data loss is called AIRC, no matter if it is located at the client or server side of the system. Although they run separately, the same risk calculation algorithm is executed by them.

The risk calculation algorithm begins at step 201 and is executed every time the timer 114 of the Data insurance Client application 101 activates the risk calculation algorithm. Whenever the risk of data loss must be calculated, the Rules Interpreter 206 is executed with two types of input, the first being the AIRC Rules table 207 extracted from the AIRC database, and the second being the customer variables which correspond to S.M.A.R.T 212, Operating System 216, Backup 214, Anti-virus 215, S.N.M.P 216, Hardware 217 and user behavior 218 variables.

Referring additionally to FIG. 14, the AIRC Rules table 207 is fed by the AIRC team 403 after detecting trends and new risks. On the other hand, the subject technology has the ability to auto detect new trends and new risks by implementing the AIRC Risk Detector 421 which automatically feeds itself with the computer failure stats 407 413, trends of behavior, combinations of behavior 409 410 412 411 406 404 performance killers 415, recovery events 417 and claims 412. The rules created by the AIRC team 403 and the ones created by the AIRC Risk Detector 409 are combined in one and stored at the AIRC rules database 408 in order to be read by the AIRC Risk calculation algorithm shown in FIG. 2.

The AIRC Risk Detector 421 will take into account all the customer variables for all the computers which present failures, medium risk of data loss, high risk of data loss and will try to find out co-relationships between them. The AIRC Risk Detector 421 will also find undiscovered risks by connecting trends and developments.

For example with reference to FIGS. 12-14F, the AIRC Risk Detector 421 has matched four computers that failed during the last month 501 502 503 504 with similarities. The AIRC Risk Detector 421 checks similar hardware features and similar computer variable behaviors finding out that all four computers have hard disks made by A HD Inc. and all four have motherboards made by B MB Inc. A multi rule can be created out of this as follows: (ID S1) “If the Hard drive is made by A HD Inc”, and used in combination with (ID S2) “the motherboard made by B MB Inc” then the risk level is orange. Two Single Rules could also be created in this case such that when both are orange or medium then the risk level is set to high or red. This multi rule appears because the AIRC Risk Detector 421 inferred from the past experience that the combination of these two products have a very high failure rate. In this way, the subject technology improves its risk calculation algorithm constantly and adapts itself automatically when the technological market changes.

The Risk Detector is explained in more detail in FIG. 16, the first step 701 is to collect all the computer's, variables from the broken computers population and store the data in a data collection or database 702. Then two sequences of process are executed in parallel, one to define the single rules and a second to define the multi rules.

Within the single rule sequence, a process 703 extracts from the data collection 702 the occurrence statistics of the values for all the computers variables. The extraction process creates a table 704 that contains mainly four columns: Variable, Value, Occurrences and Percentage. The “Variable” column include all the possible variables types of the computer, computer environment and end-user behavior. The “Value” column includes the value of the variable type. The “Occurrences” column is the number of times which that value appears at the variable type range. The last column called “Percentage” shows the percentage of hardware devices from the total population belonging to this hardware type (variable type).

The Percentage column is a strong indicator or variable. The percentage will show the incidence of this value within the population of computers elements, i.e., the hard drive with brand “A HD” has 23 occurrences in all the broken computers population, and then, these 23 occurrences belongs to the 1% of the total population of hard drives with brand “A HD” composed by 2300 units. Then this percentage of 1% (it's the percentage that is located at the table 704) is compared with the threshold for this variable type, i.e., suppose that the AIRC team or the Risk Detector by itself has defined a threshold for the Hard drive brand as 6% 706, then the percentage of the example is 1% and that means that a single rule to control this variable is not needed yet.

Alternatively, if the percentage is greater than the threshold, then a single rule 707 will be created 705 to put a risk level of orange or red related with this variable type (Hard drive brand). Note that these auto created rules can be applied immediately to the AIRC Risk management system or at least can be recommended for creation to the AIRC team. The AIRC team decides if such rules are applied or not. After the single rule creation process 705, a process which verifies if the thresholds are well defined 708 is executed and updated to create thresholds as needed.

The multi rule sequence is executed in parallel to the single rule creation process. The first step 709 of the multi rule process extract date from the data collection 702 related to all the occurrences of the combination of several variables types which have a close relationship. The result of this extraction 709 is a table 710 which contains N couples of columns where each couple is composed of a variable type and its value. For example, the first row of the table 710 or couple #1 is the pair of a Mother Board, brand XYZ with a hard drive, brand HD A. This row includes a third variable of a Processor, brand A, wherein all these values of variables belong to the same broken computer.

The next column of the table 710 is the “Occurrences”, which is the number of occurrences of this combination of variables within the broken computers population. And the last column called “Percentage” shows the percentage of broken computers from the total population of computers (Non broken and broken) which has this combination of values. Similar to the process sequence for the single rules, the next step is to compare these percentages with the thresholds 713 to determine if it a multi rule 712 is needed to control this combination of values or not. Once the multi rules are created, the next step 714 is to verify that the thresholds are well defined or create new one as needed when the thresholds are not well defined. Upon completion, the whole life cycle of the Risk Detector starts again.

AIRC Single Rules are so called because only one of the customer variables is taken into account when defining a criterion. Conversely, Multi Rules take into account several Single Rules to create criteria and, in this way, the subject technology can create all possible combinations of rules to mitigate the risk in a effective way.

FIG. 7 shows a screenshot of an example of single rule creation. Initially, the user selects a variable S501 within the types: S.M.A.R.T variables 212, Operative System variables 213, Backup variables 214, Anti-virus variables 215, Hardware variables 217, SNMP variables 216 and user behavior variables 218. Then, the user establishes the criteria using the selected variable S102 for each risk level (green, orange and red).

Next to field S503 it is shown the unit (if it has) and the data type of the value to compare the variable value. For example if the variable selected in 501 is the Hard Disk Temperature, the unit shown will be Celcius (Integer), what means that the input value should be an integer and it should be written in Celcius degrees. If the rule requires comparing a variable value with a range of values, for example, the Hard Disk Temperature between 40° C. and 50° C., it will be necessary to create two single expressions. One for Hard Disk Temperature>=(Greater or Equal than) 40° C. and the second one for Hard Disk Temperature (Lower or Equal than)<=50° C. After that a multi rule has to be created as it is shown in FIG. 8 by selecting the previous Single Expressions as Right S601 and Left S603 Expressions respectively, and selecting the operator AND from the selection list S602. If a variable extracted from a computer has more than one value (For example; S.M.A.R.T. variables has raw, current, worst, threshold . . . ) the type of the value which will use the rule should be specified with the selection list S504.

FIG. 7 shows a screenshot for creation of a criterion with a “Boolean comparison” S501. A value of true or false can be selected as reference 502. Additionally, a frequency can be specified to set up rules that require a minimum number of times being the variable true or false 503. FIG. 8 shows how to create a criterion with a “constant comparison” 601 using operators 602 like greater than, smaller than, equals to, and etc.

The Rules of similar conditions are grouped in Scenarios. A scenario will have a description and a priority. If a rule of a two different scenarios become true, the actions of the one with greater priority will override the other one. Some examples of Scenarios are below.

### Spin Up Time Scenario

Average time of spindle spin up (from zero RPM (Revolutions per Minute) to fully operational) is one scenario. “Spin up time” describes amount of time to spin the platters up to their rated rotation speed (usually 5400 or 7200 RPM), averaged over several spindle spin up times, Values above 80 seconds should be considered good. Values between 70 and 80 seconds are still acceptable. There is a known issue with Quantum (Maxtor) hard drives—out-of-the-box new drives drop “Spin up time” to 70 within first two weeks of use, causing program to predict failure within a month. This is usually a false alarm and the system can adapt to such conditions. After some initial “burn-in” period, “Spin up time” becomes constant and the drive functions normally. The raw value of this attribute indicates average time to spin up the drive spindle. Raw value is a time of milliseconds or seconds. Table 1 below shows how the spin up time scenario may be represented.

TABLE 1

| Conditions | Task |
|---|---|
| IF ((3 Spin_Up_Time < 80 ms) AND | Level to Green, Show Message |
| (3 Spin_Up_Time > 69 ms)) | |
| IF ((3 Spin_Up_Time < 70 ms) AND | Level to Orange, Show Message |
| (3 Spin_Up_Time > 64 ms)) | |
| IF (3 Spin_Up_Time < 65 ms) | Level to Red, Show Message |

### Reallocated Sectors Count Scenario

Count of reallocated sectors is another scenario. When the hard drive finds a read/write/verification error, the processor marks this sector as “reallocated” and transfers data to a special reserved area (spare area). This process is also known as remapping and “reallocated” sectors are called remaps. This is why, on a modern hard disks, one cannot see “bad blocks” while testing the surface (all bad blocks are hidden in reallocated sectors). However, the more sectors that are reallocated, the more a sudden decrease (up to 10% and more) can be noticed in the disk read/write speed. Table 2 below shows how the reallocated sectors count scenario may be represented.

TABLE 2

| Conditions | Task |
|---|---|
| IF ((5 Reallocated_Sector_Ct < 80) AND | Level to Green, |
| (5 Reallocated_Sector_Ct > 69)) | Show Message |
| IF ((5 Reallocated_Sector_Ct < 70) AND | Level to Orange, |
| (5 Reallocated_Sector_Ct > 40)) | Show Message |
| IF (5 Reallocated_Sector_Ct < 41) | Level to Red, Show Message |

### Seek Error Rate Scenario

Count of seeks errors is another scenario. When your HDD reads data, the HDD positions heads in the needed place. If there is a failure in the mechanical positioning system, a seek error arises. More seek errors (i.e. lower attribute value) indicates a poor condition of a disk surface and disk mechanical subsystem with a corresponding increase in frequency of errors appearance while positioning. Table 3 below shows how the seek error rate scenario may be represented.

TABLE 3

| Conditions | Task |
|---|---|
| IF ((7 Seek_Error_Rate < 75) AND | Level to Orange, Show Message |
| (7 Seek_Error_Rate > 62)) | |
| IF (7 Seek_Error_Rate < 60) | Level to Red, Show Message |

### Power On Count Scenario

Power on count is another exemplary scenario. Raw value of this attribute indicates how long the drive has been working (e.g., powered on). Sense of this attribute is identical or at least similar with the attribute Device/Drive Power Cycle Count, which shows count of start/stop cycles of hard drive. Decreasing of the power on count value to threshold means exhausted lifetime of drive (e.g., MTBF—Mean Time Between Failures). Table 4 below shows how the power on count scenario may be represented.

TABLE 4

| Condition | Task |
|---|---|
| IF ((9 Power_On_Hours < 10 h) AND | Level to Green, Show Message |
| (9 Power_On_Hours > 5 h)) | |
| IF ((9 Power_On_Hours < 6 h) AND | Level to Orange, Show Message |
| (9 Power_On_Hours > 0 h)) | |
| IF (9 Power_On_Hours < 1 h) AND | Level to Red, Show Message |
| (9 Power_On_Hours < 1 h) before | |

### Spin Up Retry Count Scenario

Count of retry of spin start attempts is another scenario. This attribute stores a total count of the spin start attempts to reach the fully operational speed, under the condition that the first attempt was unsuccessful. A decrease of this attribute value is a sign of problems in the hard disk mechanical subsystem. Table 5 below shows how the sign up retry count scenario may be represented.

TABLE 5

| Condition | Task |
|---|---|
| IF ((10 Spin_Retry_Count < 100) AND | Level to Orange, |
| (10 Spin_Retry_Count > 97)) | Show Message |
| IF (10 Spin_Retry_Count < 98) | Level to Red, Show Message |

Referring again to the customer variable input shown in FIG. 2, the first sub-set of variables is the S.M.A.R.T variables 212. S.M.A.R.T. technology was originally developed for use with hard drives, and is described in SFF committee, Specification Self-Monitoring, Analysis and Reporting Technology, SFF-8035i, revision 2.0, Apr. 1, 1996, which is incorporated herein by reference. There are more S.M.A.R.T variables but an exemplary list of monitored S.M.A.R.T variables are shown below in Table 6.

TABLE 6
Legend

| ID | Hex | Attribute name | Better | Description |
|---|---|---|---|---|
| 01 | 01 | Read Error Rate | | Indicates the rate of hardware read errors that |
| | | | | occurred when reading data from a disk |
| | | | | surface. The raw value has different structure |
| | | | | for different vendors and is often not |
| | | | | meaningful as a decimal number. |
| 02 | 02 | Throughput Performance | [symbol] | Overall (general) throughput performance of a |
| | | | | hard disk drive. If the value of this attribute is |
| | | | | decreasing there is a high probability that there |
| | | | | is a problem with the disk. |
| 03 | 03 | Spin-Up Time | [symbol] | Average time of spindle spin up (from zero |
| | | | | RPM to fully operational [millisecs]). |
| 04 | 04 | Start/Stop Count | | A tally of spindle start/stop cycles. The spindle |
| | | | | turns on, and hence the count is increased, both |
| | | | | when the hard disk is turned on after having |
| | | | | before been turned entirely off (disconnected |
| | | | | from power source) and when the hard disk |
| | | | | returns from having previously been put to |
| | | | | sleep mode. |
| 05 | 05 | Reallocated Sectors Count | [symbol] | Count of reallocated sectors. When the hard |
| | | | | drive finds a read/write/verification error, it |
| | | | | marks this sectors as “reallocated” and transfers |
| | | | | data to a special reserved area (spare area). |
| | | | | This process is also known as remapping, and |
| | | | | “reallocated” sectors are called remaps. This is |
| | | | | why, on modern hard disks, “bad blocks” |
| | | | | cannot be found while testing the surface all |
| | | | | bad block are hidden in reallocated sectors. |
| | | | | However, as the number of reallocated sectors |
| | | | | increases, the read/write speed tends to |
| | | | | decrease. The raw value normally represents a |
| | | | | count of the number of bad sectors that have |
| | | | | been found and remapped. Thus, the higher the |
| | | | | attribute value, the more sectors the drive has |
| | | | | had to reallocate. |
| 06 | 06 | Read Channel Margin | | Margin of a channel while reading data. The |
| | | | | function of this attribute is not specified. |
| 07 | 07 | Seek Error Rate | | Rate of seek errors of the magnetic heads. If |
| | | | | there is a partial failure in the mechanical |
| | | | | positioning system, then seek errors will arise. |
| | | | | Such a failure may be due to numerous factors, |
| | | | | such as damage to a servo, or thermal widening |
| | | | | of the hard disk. The raw value has different |
| | | | | structure for different vendors and is often not |
| | | | | meaningful as a decimal number. |
| 08 | 08 | Seek Time Performance | [symbol] | Average performance of seek operations of the |
| | | | | magnetic heads. If this attribute is decreasing, |
| | | | | it is a sign of problems in the mechanical |
| | | | | subsystem. |
| 09 | 09 | Power-On Hours (POH) | [symbol] | Count of hours in power-on state. The raw |
| | | | | value of this attribute shows total count of |
| | | | | hours (or minutes, or seconds, depending on |
| | | | | manufacturer) in power-on state. |
| 10 | 0A | Spin Retry Count | [symbol] | Count of retry of spin start attempts. This |
| | | | | attribute stores a total count of the spin start |
| | | | | attempts to reach the fully operational speed |
| | | | | (under the condition that the first attempt was |
| | | | | unsuccessful). An increase of this attribute |
| | | | | value is a sign of problems in the hard disk |
| | | | | mechanical subsystem. |
| 11 | 0B | Recalibration Retries | [symbol] | This attribute indicates the number of times |
| | | Calibration_Retry_Count | | recalibration was requested (under the |
| | | | | condition that the first attempt was |
| | | | | unsuccessful). An increase of this attribute |
| | | | | value is a sign of problems in the hard disk |
| | | | | mechanical subsystem. |
| 12 | 0C | Power Cycle Count | | This attribute indicates the count of full hard |
| | | | | disk power on/off cycles. |
| 13 | 0D | Soft Read Error Rate | [symbol] | Uncorrected read errors reported to the |
| | | | | operating system. |
| 183 | B7 | SATA Downshift Error Count | | Western Digital and Samsung attribute. |
| 184 | B8 | End-to-End error | [symbol] | This attribute is a part of HP's SMART TV |
| | | | | technology and it means that after transferring |
| | | | | through the cache RAM data buffer the parity |
| | | | | data between the host and the hard drive did |
| | | | | not match. |
| 185 | B9 | Head Stability | | Western Digital attribute. |
| 186 | BA | Induced Op-Vibration Detection | | Western Digital attribute. |
| 187 | BB | Reported Uncorrectable Errors | [symbol] | A number of errors that could not be recovered |
| | | | | using hardware ECC (see attribute 195). |
| 188 | BC | Command Timeout | [symbol] | A number of aborted operations due to HDD |
| | | | | timeout. Normally this attribute value should |
| | | | | be equal to zero and if the value is far above |
| | | | | zero, then most likely there will be some |
| | | | | serious problems with power supply or an |
| | | | | oxidized data cable. |
| 189 | BD | High Fly Writes | [symbol] | HDD producers implement a Fly Height |
| | | | | Monitor that attempts to provide additional |
| | | | | protections for write operations by detecting |
| | | | | when a recording head is flying outside its |
| | | | | normal operating range. If an unsafe fly height |
| | | | | condition is encountered, the write process is |
| | | | | stopped, and the information is rewritten or |
| | | | | reallocated to a safe region of the hard drive. |
| | | | | This attribute indicates the count of these errors |
| | | | | detected over the lifetime of the drive. |
| | | | | This feature is implemented in most modern |
| | | | | Seagate drives and some of Western Digital's |
| | | | | drives, beginning with the WD Enterprise |
| | | | | WDE18300 and WDE9180 Ultra2 SCSI hard |
| | | | | drives, and will be included on all future WD |
| | | | | Enterprise products. |
| 190 | BE | Airflow Temperature (WDC) | [symbol] | Airflow temperature on Western Digital HDs |
| | | | | (Same as temp. [C2], but current value is 50 |
| | | | | less for some models. Marked as obsolete.) |
| 190 | BE | Temperature Difference from 100 | [symbol] | Value is equal to (100 - temp. ° C.), allowing |
| | | | | manufacturer to set a minimum threshold |
| | | | | which corresponds to a maximum temperature. |
| | | | | (Seagate only?) |
| | | | | Seagate ST910021AS: Verified Present |
| | | | | Seagate ST9120823ASG: Verified Present |
| | | | | under name “Airflow Temperature Cel” 2008- |
| | | | | 10-06 |
| | | | | Seagate ST3802110A: Verified Present 2007- |
| | | | | 02-13 |
| | | | | Seagate ST980825AS: Verified Present 2007- |
| | | | | 04-05 |
| | | | | Seagate ST3320620AS: Verified Present 2007- |
| | | | | 04-23 |
| | | | | Seagate ST3500641AS: Verified Present 2007- |
| | | | | 06-12 |
| | | | | Seagate ST3250824AS: Verified Present 2007- |
| | | | | 08-07 |
| | | | | Seagate ST3250620AS: Verified Present |
| | | | | Seagate ST31000340AS: Verified Present |
| | | | | 2008-02-05 |
| | | | | Seagate ST31000333AS: Verified Present |
| | | | | 2008-11-24 |
| | | | | Seagate ST3160211AS: Verified Present 2008- |
| | | | | 06-12 |
| | | | | Seagate ST3320620AS: Verified Present 2008- |
| | | | | 06-12 |
| | | | | Seagate ST3400620AS: Verified Present 2008- |
| | | | | 06-12 |
| | | | | Seagate ST3750330AS: Verified present 2009- |
| | | | | 07-06 |
| | | | | Seagate ST3500418AS: Verified present 2010- |
| | | | | 04-03 |
| | | | | Samsung HD501LJ: Verified Present under |
| | | | | name “Airflow Temperature” 2008-03-02 |
| | | | | Samsung HD753LJ: Verified Present under |
| | | | | name “Airflow Temperature” 2008-07-15 |
| 191 | BF | G-sense error rate | [symbol] | The number of errors resulting from externally- |
| | | | | induced shock & vibration. |
| 192 | C0 | Power-off Retract Count | [symbol] | Number of times the heads are loaded off the |
| | | Emergency Retract Cycle count (Fujitsu) | | media. Heads can be unloaded without actually |
| | | | | powering off. |
| 193 | C1 | Load Cycle Count | [symbol] | Count of load/unload cycles into head landing |
| | | Load/Unload Cycle Count (Fujitsu) | | zone position. |
| | | | | The typical lifetime rating for laptop (2.5-in) |
| | | | | hard drives is 300,000 to 600,000 load cycles. |
| | | | | Some laptop drives are programmed to unload |
| | | | | the heads whenever there has not been any |
| | | | | activity for about five seconds. Many Linux |
| | | | | installations write to the filesystem a few times |
| | | | | a minute in the background. As a result, there |
| | | | | may be 100 or more load cycles per hour, and |
| | | | | the load cycle rating may be exceeded in less |
| | | | | than a year. |
| 194 | C2 | Temperature | [symbol] | Current internal temperature. |
| 195 | C3 | Hardware ECC Recovered | | The raw value has different structure for |
| | | | | different vendors and is often not meaningful |
| | | | | as a decimal number. |
| 196 | C4 | Reallocation Event Count | [symbol] | Count of remap operations. The raw value of |
| | | | | this attribute shows the total number of |
| | | | | attempts to transfer data from reallocated |
| | | | | sectors to a spare area. Both successful & |
| | | | | unsuccessful attempts are counted. |
| 197 | C5 | Current Pending Sector Count | [symbol] | Number of “unstable” sectors (waiting to be |
| | | | | remapped, because of read errors). If an |
| | | | | unstable sector is subsequently written or read |
| | | | | successfully, this value is decreased and the |
| | | | | sector is not remapped. Read errors on a sector |
| | | | | will not remap the sector (since it might be |
| | | | | readable later); instead, the drive firmware |
| | | | | remembers that the sector needs to be |
| | | | | remapped, and remaps it the next time it's |
| | | | | written. |
| 198 | C6 | Uncorrectable Sector Count | [symbol] | The total number of uncorrectable errors when |
| | | | | reading/writing a sector. A rise in the value of |
| | | | | this attribute indicates defects of the disk |
| | | | | surface and/or problems in the mechanical |
| | | | | subsystem. (or Off-Line Scan Uncorrectable |
| | | | | Sector Count - Fujitsu)^{[16]} |
| 199 | C7 | UltraDMA CRC Error Count | [symbol] | The number of errors in data transfer via the |
| | | | | interface cable as determined by ICRC |
| | | | | (Interface Cyclic Redundancy Check). |
| 200 | C8 | Multi-Zone Error Rate (Western Digital) | [symbol] | |
| 200 | C8 | Write Error Rate (Fujitsu) | [symbol] | The total number of errors when writing a |
| | | | | sector. |
| 201 | C9 | Soft Read Error Rate | [symbol] | Number of off-track errors. |
| 202 | CA | Data Address Mark errors | [symbol] | Number of Data Address Mark errors (or |
| | | | | vendor-specific). |
| 203 | CB | Run Out Cancel | [symbol] | Number of ECC errors |
| 204 | CC | Soft ECC Correction | [symbol] | Number of errors corrected by software ECC |
| 205 | CD | Thermal Asperity Rate (TAR) | [symbol] | Number of errors due to high temperature. |
| 206 | CE | Flying Height | | Height of heads above the disk surface. A |
| | | | | flying height that's too low increases the |
| | | | | chances of a head crash while a flying height |
| | | | | that's too high increases the chances of a |
| | | | | read/write error. |
| 207 | CF | Spin High Current | [symbol] | Amount of surge current used to spin up the |
| | | | | drive. |
| 208 | D0 | Spin Buzz | | Number of buzz routines needed to spin up the |
| | | | | drive due to insufficient power. |
| 209 | D1 | Offline Seek Performance | | Drive's seek performance during its internal |
| | | | | tests. |
| 211 | D3 | Vibration During Write | | Vibration During Write |
| 212 | D4 | Shock During Write | | Shock During Write |
| 220 | DC | Disk Shift | [symbol] | Distance the disk has shifted relative to the |
| | | | | spindle (usually due to shock or temperature). |
| | | | | Unit of measure is unknown. |
| 221 | DD | G-Sense Error Rate | [symbol] | The number of errors resulting from externally- |
| | | | | induced shock & vibration. |
| 222 | DE | Loaded Hours | | Time spent operating under data load |
| | | | | (movement of magnetic head armature) |
| 223 | DF | Load/Unload Retry Count | | Number of times head changes position. |
| 224 | E0 | Load Friction | [symbol] | Resistance caused by friction in mechanical |
| | | | | parts while operating. |
| 225 | E1 | Load/Unload Cycle Count | [symbol] | Total number of load cycles |
| 226 | E2 | Load ‘In’-time | | Total time of loading on the magnetic heads |
| | | | | actuator (time not spent in parking area). |
| 227 | E3 | Torque Amplification Count | [symbol] | Number of attempts to compensate for platter |
| | | | | speed variations |
| 228 | E4 | Power-Off Retract Cycle | [symbol] | The number of times the magnetic armature |
| | | | | was retracted automatically as a result of |
| | | | | cutting power. |
| 230 | E6 | GMR Head Amplitude | | Amplitude of “thrashing” (distance of |
| | | | | repetitive forward/reverse head motion) |
| 231 | E7 | Temperature | [symbol] | Drive Temperature |
| 240 | F0 | Head Flying Hours | | Time while head is positioning |
| 240 | F0 | Transfer Error Rate (Fujitsu) | | Counts the number of times the link is reset |
| | | | | during a data transfer. |
| 241 | F1 | Total LBAs Written | | Total LBAs Written |
| 242 | F2 | Total LBAs Read | | Total LBAs Read |
| | | | | Some S.M.A.R.T. utilities will report a |
| | | | | negative number for the raw value since in |
| | | | | reality it has 48 bits rather than 32. |
| 250 | FA | Read Error Retry Rate | [symbol] | Number of errors while reading from a disk |
| 254 | FE | Free Fall Protection | [symbol] | Number of “Free Fall Events” detected |

[symbol]

Higher raw value is better [symbol]
Lower raw value is better
Critical - red colored row
Potential indicators of imminent electromechanical failure

As shown in FIGS. 2A-E, another input for the Rules interpreter 206 is conformed by the O.S. variables 213. These variables help the risk calculation by showing if the O.S. is updated and has all the patches installed in order to avoid any security holes. Additionally, the subject technology detects problems related with certain application behaviors like excessive memory or processor consumption, and/or excessive I/O operations that may put in risk the hard disk of the customer. The subject technology will notify and recommend the end user with expected actions to solve this kind of problems. The variables which are monitored are shown below in Table 7.

TABLE 7

| No. | O.S. Variables description |
|---|---|
| 1 | Operating System Version |
| 2 | Operating System Updates |
| 3 | Kernel version |
| 4 | Application and Services running |
| 5 | Processor model |
| 6 | Processor speed |
| 7 | Processor average load test (%) |
| 8 | Processor average load duration |
| 9 | Physical Memory |
| 10 | System time-zone |
| 11 | Computer utilization time |
| 12 | System Logs |
| 13 | O.S. Firewall Status and alerts |
| 14 | Amount of Peaks of memory and CPU consumption |

As shown in FIGS. 2A-E, another input for the Rules interpreter 206 is the set of backup variables 214. The backup process helps in mitigating the risk by making a copy for each insured file of the customer storage media. Single or multiple rules can put the risk level in red when the backup is not made in certain amount of time. The following variables of the backup process shown in Table 8 can be monitored by the subject technology.

TABLE 8

| No. | Backup Variables description |
|---|---|
| 1 | File System tree |
| 2 | Date of the last successful backup |
| 3 | Status of the Backup repository connection |
| 4 | List of files which were backed up successfully |
| 5 | List of files which are pending for backup |
| 6 | Number of successful and failed backups |
| 7 | Network jumps between the customer and the |
| | Backup repository location |
| 8 | Upload Speed to the Backup Repository |
| 9 | Download Speed to the Backup Repository |
| 10 | Backup total size (quota) |
| 11 | Backup schedule |
| 12 | Number of successful and failed recoveries |

Still referring to FIGS. 2A-E, another input for the Rules interpreter 206 is the Anti-virus set of variables 215. A computer system without antivirus protection is in general more prone to data loss than others with antivirus protection. The AIRC algorithm takes this element into consideration for the single and Multi Rule definition and rules like ‘a customer who does not have any anti-virus installed will be assigned a red risk level, while a customer with an out of date anti-virus with virus definitions not older than one day will be assigned orange risk level” can be created. The following variables of the Anti-virus system shown in Table 9 can be monitored by the subject technology.

TABLE 9

| No. | Anti-virus Variables description |
|---|---|
| 1 | Anti-virus type |
| 2 | Anti-virus Name |
| 3 | Anti-virus Version |
| 4 | Is this the last version? (true/false) |
| 5 | Anti-virus Company |
| 6 | Version of virus definitions |
| 7 | Scan schedule and its fulfillment |
| 8 | Scan results |

As shown in FIGS. 2A-E another input for the Rules interpreter 206 is the set of S.N.M.P variables 222. The Simple Network Management Protocol (SNMP) is used in network management systems to monitor network-attached devices for conditions that warrant administrative attention. SNMP is a component of the Internet Protocol Suite as defined by the Internet Engineering Task Force (IETF). It consists of a set of standards for network management, including an application layer protocol, a database scheme, and a set of data objects. SNMP exposes management data in the form of variables on the managed systems, which describe the system configuration. These variables can then be queried (and sometimes set) by managing applications, like the AIRC. The following variables of the SNMP protocol shown in Table 10 can be monitored by the subject technology.

TABLE 10

| No. | S.N.M.P. Variables description |
|---|---|
| 1 | CPU Usage % |
| 2 | Memory Usage % |
| 3 | Network Traffic in |
| 4 | Network Traffic out |
| 5 | Network Traffic history |
| 6 | Network bandwidth |
| 7 | Network Traffic per Protocol |
| 8 | Hard disk I/O rates |
| 9 | All Hardware sensors offered by the private MIB of the device |
| 10 | All Hardware sensors offered by the standard MIB of the SNMP |
| | protocol |

As shown in FIGS. 2A-E another input for the Rules interpreter 206 is the Hardware set of variables 217. It is very important to know the hardware specification of the customer computer; with it the subject technology is able to detect trends related with hardware brands or models and in this way predict the risk level well enough to avoid and/or mitigate the risk of data loss. The following Hardware variables shown in Table 11 can be monitored by the subject technology.

TABLE 11

| No. | Hardware Variables description |
|---|---|
| 1 | Mother board Serial/Brand/Model |
| 2 | Processor Serial/Brand/Model/Speed |
| 3 | IDE/SCSI/SATA/ATA Drivers |
| 4 | Processor Temperature |
| 5 | Is Processor working with over-clocking |
| 6 | Network cards |
| 7 | Storage Drivers |
| 8 | BIOS Serial/Brand/Model/Firmware/Drivers |
| 9 | USB Ports and Drivers |
| 10 | PCI Port and Drivers |
| 11 | Hard disk drivers |

Another input for the Rules interpreter 206 is the customer behavior set of variables 218. The risk calculation may not be complete if the subject technology does not include the customer behavior regarding the computer usage, i.e., if the customer shuts down the computer improperly very often then the risk level must be red. The following variables of the customer behavior shown in Table 12 can be monitored by the subject technology

TABLE 12

| No. | Customer Behavior |
|---|---|
| 1 | How often the user connects Internet |
| 2 | How often the user shutdown the computer in a bad way |
| 3 | Does the user follows the recommendations which the subject |
| | technology popup |
| 4 | How often the user installs new application |
| 5 | How many applications the user runs at the same time |
| 6 | How often the user restarts the computer |
| 7 | How often the user hibernate the computer |
| 8 | The type of data does the customer work with. |

One example of how to take advantage from the customer behavior is monitoring how many applications and processes the customer is running at the same time. In the even that the real memory is not enough to support this memory load, the Operating System starts to swap memory pages between real and virtual memory. Since the virtual memory is located actually on the hard disk, this makes the I/O load greater than normal and in this way the risk of hard drive failure increases. If the virtual memory reserved by the Operating System is not enough, all the process and applications would start to freeze resulting in the system being unstable. This could also degenerate into an improper shutdown because the system is not responding. In such circumstances, the integrity of files gets affected and the risk of data loss increases.

The subject technology is able to create risk calculation rules for any variable which can be extracted from the customer computer. The respective AIRC rule establishing the ranges of possible values for new variables and the criterion to be in green, orange or red risk levels. That is the dynamic nature of the subject technology. For example, when the data insurance company or a manufacturer detects a firmware problem in certain hard drive model, the risk level goes to red until the customer updates it or exchanges the drive. As with the same hard drive, the level will be green until a risk, such as the one noted above, is discovered. This is a good example of dynamic risk management that is constantly improving to eliminate the risk of data loss.

Additionally, as result of low risk or eliminated risk, the data insurance company and the alliance partners invest large amounts of premium in research and support in order to offer the best services to the customers in order to improve the dynamic risk management system. This is another way to prevent and manage the risk for the data insurance.

Continuing with the AIRC risk calculation algorithm shown in FIGS. 2A-E, after the Rules Interpreter 206 is executed with the rules 207 using the inputs 212 213 214 215 216 217, a Rules results are generated. Each rule will specify if the risk level 227 must be green, orange or red and the duration this level must have. The subject technology will establish as risk level the highest result (Red>Orange>Green) of the entire rule results. The Multi expressions of a Rule 221 take into account two or more Single expressions and for that reason, the subject technology is able to create rules for risk calculation including more than one customer variable, i.e., HD temperature, Processor over clocking and upload throughput. The subject technology establishes a new risk level 216 different than the risk level specified by the Single Rules separately. Take the following case as example to illustrate better what is mentioned above. Rules can have as condition multi expressions involving more than one variable. It means that it is able to analyze scenarios where two conditions together

In another embodiment, the duration or a level will be the maximum specified by all the rules which were true for the highest risk level. If the resulting risk level was green for all the Rules and is not needed to calculate multi rules, then the next risk calculation is scheduled and the AIRC risk calculation algorithm will wait for the next calculation event. If all the single rules were green but multi rules are needed to be calculated, then the Multi Rules interpreter is executed. Otherwise, if not all single rules were green then, the orange or red risk level is established and the Multi Rules interpreter is executed having Single Rules results and Multi Rules table as input. The Multi Rules take into account two or more Single Rules and for that reason, the subject technology is able to create rules for risk calculation including more than one customer variable, e.g., HD temperature, Processor over clocking and upload throughput. The subject technology establishes a new risk level different than the risk level specified by the Single Rules separately. It is also possible to have a multi rule which extends the duration of the current risk level.

As noted above, the subject technology establishes a new risk level 216 different than the risk level specified by the Single Rules separately. The following exemplary case to illustrates what is mentioned above. Tables 13 and 14 below, illustrate single rule and multi rule tables, respectively. If the S1 risk level result was Orange and the S2 risk level result was Orange, then rule C1 is true, therefore the new risk level is set to Red and the new duration for this risk level for 2880 running time hours. The Multi expression for Large backup pending of Table 14 will be true when both of the Single expressions S1 and S2 will be true.

TABLE 13

| ID | Customer variable | Operator | Constant |
|---|---|---|---|
| S1 | Backup pending | Equals | true |
| S2 | Size of modified | Greater than | 10 Gb |
| | files | | |

TABLE 14

| | | | | Compound |
|---|---|---|---|---|
| | | Specific | Specific | Rule Risk |
| ID | Multi rule Name | Rule | Rule | Level |
| C1 | Large backup pending | S1 | S2 | Orange |

Going back to the AIRC Algorithm FIGS. 2A-E, after the risk level, the Rules Interpreter 206 is executed and Rules results are stored as issues at step 228. The next step is to execute the expected actions defined by the AIRC team and the AIRC Risk detector. These actions depend on the Rules results and the expected actions table 232. The expected actions table defines the actions to be taken per rule evaluated to true, i.e., if C1 is true then the Data Insurance Client Application recommends to the user to not turn off the computer. If the Data Insurance Client Application is working with a third-party provider for the backup module, the Data Insurance Client application will order the third-party application to make the backup, and will monitor this process.

After executing the expected action 232, the next step is to send all the risk calculation results to the AIRC historical database 331. This allows detection of trends and new risk types by the AIRC system. This may conclude with new rules of risk calculation being created automatically. After this step is completed, the next calculation event is scheduled 221 by the Task Manager 117 and the AIRC algorithm waits for the next risk calculation 201. If the Data Insurance Client application is offline, then the risk calculation algorithm will save this information to the hard drive in order to be included into a retransmission line, which is started when the application detects that the network is available again.

The Universal Repository Connector is in charge to manage the Backup repositories located on Internet or in private networks. These repositories are the backup destinations for all the customer's files which are selected to be insured. This Universal Repository Connector brings the capability to the customers for selecting the amount of repositories they prefer to back up to. The subject technology brings the possibility to the customer for selecting the backup repositories of their preference.

The Universal Repository Connector will use MD5 functions to check the integrity of the backed up files. The Universal Repository Connector class has multiple connectors targeting to different backup repositories. To implement the multi-destination backup and file moving between different repositories, the subject technology must manage the different types of backup repository translators like SOAPS3Client and SOAPBoxnetClient in a standard way in order to pass them as parameters to BackupFile( ) method, and avoiding the implementation of specific methods per each backup repository.

The subject technology uses an interface called Repository Connector Interface which defines generic methods to create/delete containers, i.e. containers in S3 will be buckets and on Box.net folders. This interface also defines methods to download/upload files. As a consequence all these translators: SOAPS3Client, SOAPBoxnetClient, JSONXDriveClient, WebDaviDiskClient, will implement the Repository Connector Interface with these abstract methods. This interface will keep the compatibility which enables the Data Insurance application to manage all the backup repositories in the same way no matter if the communication protocol or containers are different. Under this model the subject technology defines a set of translators or repository connectors implementing a unique Repository Connector Interface.

In FIG. 13, the general topology of the Data Insurance System is described. The main objective is to show the interconnections between each element presented above in this document. The subject technology is composed by four sides. The first one is the Customer side. This side is composed of a Customer computer which can be laptop, desktop, server, etc. which previously has installed the client application that includes a Data Insurance Service 304, 101. This Service 304 has several software modules running at the same time, the GSDC client 306, the AIRC Client 307, the CRM client 305, the OBFMD client 308 and the GUI 303. The GSDC client 306 is in charge of extracting the Customer variables from his computer 212, 213, 214, 215, 216, 217 in order to gather the information necessary to calculate the risk of data loss.

The AIRC client 307 is in charge of calculating the risk using the customer variables extracted by the GSDC client 306. The AIRC client calculates the risk and also manages the risk whenever the computer is offline (e.g., when the AIRC server 324 cannot be contacted). When the AIRC client 307 calculates the risk, the AIRC client 307 confirms the result with the AIRC server 324 which has always the last version of the risk calculation rules. This confirmation avoids or at least decreases any possibility of fraud made by third-parties hacking the client application. The OBFMD client 308 is in charge of monitoring the changes of insured files and of sending them to the backup repository using the Universal Repository Connector 312.

The Universal Connector 308 is the library which creates the network communications between customer and server sides. This library implements a Secure Socket Layer with encryption technology to ensure that it is not possible to manipulate the payload of each packet of data, avoiding any possibility of hacking. The Universal Repository Connector 312 is a library able to connect several types of backup repositories at the same time in order to offer the customers the possibility for selecting several backup destinations.

At the server side, the Gateway Service 318 is in charge of routing the traffic received from all the client applications to the proper MZ server which will process the client request. This Gateway service 318 keeps the MZ servers identity hidden from Internet users. The only services that the client applications and third-parties can see, that are located in the DMZ of the network topology of the Data Insurance System, are Gateway Servers 318, Repository Gateway 320 and the Third-party API server 320. All the DMZ servers connect to the MZ servers through a Client Connector 321 which is a library that knows all the other servers interfaces and where they can be called.

The GSDC Service 323 is in charge of collecting all the Customer Computer variables for all the customers of the Data insurance System. The AIRC service 324 is in charge of creating new risk rules and calculating the risk level for all the customers' computers. The OBFMD Service 327 is in charge of keeping track of the backup schedule fulfilling, file tracking, the files lists selected to be backed up and the quota management on the backup repository. The subject technology has the possibility to use backup repositories from third-party providers and/or have its own backup repository. The CRM service 328 is in charge of managing the customer resources like account information, claims and bills.

In order to avoid any possibility of fraud by altering the date and time at the customer's computer the data insurance system has its own Time Server 325 which offers the time and date to the other modules of the Data Insurance System and the customer's O.S.

The subject technology is able to horizontally grow in order to implement load balancing when the number of customers requires so. An INDEX service 330 is needed to identify in which server is located the customer information, given that the subject technology can define several CRM servers, several GSDC servers, several AIRC servers, etc. and distribute the load of processing among them. Third-parties offering online backup services can additionally offer the data insurance service to their clients by connecting the third-party API server 317, which is an RPC server that can be implemented using any RPC protocols. This third-party API allows an online backup provider to insure data and calculate the risk using the AIRC risk calculation algorithm of the subject technology.

In FIGS. 15A and 15B, a business model of a data insurance company 601 is shown. The subject technology has the approach of offering the data insurance service to customers as Super Novice Users, Novice Users, Home Network Manager, Online Backup Customers, SOHO Users and company's IT Managers. The data insurance company 601 is divided in three parts: technology division, services division and insurance division. The technology division is responsible for the innovation in product design, development, concept development and software engineering. Services division is in charge of generating income by giving support towards alliance partners, OEM partners and end-users. The services division contains a sales department selling the services under responsibility of the Chief Operating Officer, responsible for worldwide sales and operations. The insurance division is composed by the AIRC team 403 (risk assessment experts, see FIGS. 14A and 14B) whose main functions are monitoring and managing the risks of data loss, claims trends, claim handling, fraud.

The data insurance company 601 will establish alliance partnerships with Bank alliance partners 610, Insurance Alliance partners 611, Backup providers 604, Hard drive manufacturers 605, hard drive case manufacturers 606, Niche Market(s) such as credit card companies, airliners etc. 607, computers manufacturers 608 and retailers 609. All these partners will bring customers to the data insurance company, and these customers will bring knowledge to improve the risk management system.

The data insurance company has several ways to make money which are: charging their customers indirectly by alliance partners or directly by eliminating the risk of data loss with a very low premium, collecting related statistics in order to improve the AIRC risk management system and with these improvements the subject technology will be able to inform the third-parties about problems regarding hardware and software found on their products and then the data insurance company will ask to be included into the third-parties products in compensation to keep them informed about the problems that the subject technology detects on their products. The data insurance company will be offered by retailers. All alliance partners will receive a margin on the premium, and will receive kickback fee for the aftersales and yearly policy renewals. In the same way, the data insurance company will charge for reselling third-party services too like online backup services or certified hardware and/or software. The data insurance company will charge in order to certificate the storage repository providers, their storage methods and backup models implemented by third-parties to create an independent ‘signature of quality’ at the market of data storage. In the same way the data insurance company will charge for certifying PC's, laptops, servers, external cases, data repositories centers, network attached storages, etc. Also, the data insurance company will charge other companies for licensing non-exclusively the use of the subject technology in their services and products.

Note that the data insurance company will have a support team which could be inside the company or implemented by a third-party. This support team will guide the customers to effectively insure their more valuable data, i.e., when a customer starts up the data insurance application then this application will ask a question such as “Do you have any bookkeeping software?” If the customer clicks on the ‘yes I do’ button, immediately a trigger is fired by the CRM service in order to notify a member of the support team to call the customer to make questions in order to know which bookkeeping software the customer has installed. Then the support team will guide the customer to select the proper country specific bookkeeping software files/file extensions to insure this important data. This could otherwise be forgotten by the customer.

One-click-secure button, also called One-click-insure button, is created so the customer can insure his data in one single click on a button. The client application 101 will automatically select all the important files, of the user for insurance and the uses are insured. The user can view the not insured files in an separate tab in the client application 101. In case new files are created the user can insure them in one single click with the One-click-secure button.

As can be seen, the data insurance company uses a designed 3-way protection approach including: minimizing the risk of data loss; restoration of data in case of a loss; and financial coverage for non restorable data loss.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

1. A method for calculating the risk of data loss comprising the steps of:
creating a risk management system based on single and multi rules by analyzing statistics of computer failures, wherein the rules define a risk level of a customer computer;
generating the risk level using the rules;
comparing the risk level to a reference value;
determining a status selected from low, medium and high risk of data loss based on the comparison; and
assigning the status for a period of time based on one of the single rules.

2. A method as recited in claim 1, wherein the rules are based on variables extracted from the customer's computer and environment including S.M.A.R.T. hard disk variables, Operative Systems variables, Backup Process variables, Anti-virus variables, O.S. Firewall variables, S.N.M.P services variables, Hardware features and end-user behavior.

3. A method as recited in claim 1, wherein the single and multi rules are created manually by a risk management team.

4. A method as recited in claim 1, wherein the single and multi rules are created automatically by a software routine.

5. A method as recited in claim 1, wherein the single rules contain reference values that are compared against single computer variables per rule.

6. A method as recited in claim 1, wherein the risk level is generated by a single rule interpreter module which checks the rules against a computer's variables and a result is generated per rule.

7. A method as recited in claim 6, further comprising the step of passing each result of the single rule interpreter module to a multi rules interpreter module that combines the results and included independent risk level duration values.

8. A method as recited in claim 7, further comprising the steps of periodically recalculating the risk level and overwriting old values with new values.

9. A method as recited in claim 7, further comprising the step of mitigating risk of data loss based on automatic execution of actions that lead the risk level to low, wherein the actions are defined manually by a risk management team and by a risk management system by analyzing computer failure statistics and trends.

10. A method as recited in claim 7, wherein the actions are selected from the group consisting of: a system reboot; data backup; updating an operating system; blocking network traffic for the respective computer; creating a new Firewall policy to block suspicious traffic; and combinations thereof.

11. A method as recited in claim 1, wherein the computer failures relate to loss of data.

12. A method as recited in claim 1, further comprising the steps of insuring files, scanning the files, detecting blocks of insured files that have been changed, and storing the changed blocks locally and via backup repositories through the Internet in order to implement an incremental backup.

13. A method as recited in claim 12, further comprising the steps of extracting variables related to the insured files.

14. A server for facilitating a diagnostic tool, a backup tool and an insurance service, wherein the server communicates with clients via a distributed computing network, and wherein the server comprises:
(a) a memory storing an instruction set and data related to a plurality of rules defining a risk level of a client; and
(b) a processor for running the instruction set, the processor being in communication with the memory and the distributed computing network, wherein the processor is operative to:
(i) create a risk management system based on the rules by analyzing statistics of computer failures;
(ii) generate the risk level using the rules and variables related to the client;
(iii) compare the risk level to a reference value;
(iv) determine a status selected from low, medium and high risk of data loss based on the comparison;
(v) assign the status for a period of time;
(vi) calculate an insurance premium related to data files of the client based upon the rules and variables related to the client; and
(vii) undertake remedial action when the status is high risk, wherein such action includes backup of the data files.

15. A server as recited in claim 14, wherein the server is further operative to discard, accept and modify the rules under assessment.

16. A method of risk detection for assessing loss of data, providing preemptive measures against data loss, and remedial action in an event of data loss comprising:
identifying trends in computer failures based upon previous failure data;
creating rules based on the trends;
updating the failure data;
revising the trends based upon the updated failure data;
revising the rules based on the revised trends;
applying the rules to a client having client data associated with a customer;
applying corrective action to the client computer based upon violation of the rules;
providing insurance to the customer based upon the rules, configuration of the client computer, and performance of the client computer.

17. A method of risk detection as recited in claim 16, further comprising the step of providing technical support to the customer to improve performance of the client computer, wherein the client computer is a network of computers.

18. A method of risk detection as recited in claim 16, further comprising the step of contracting with third party vendors to perform the corrective action.

19. A method of risk detection as recited in claim 16, further comprising the steps of manually creating the single and multi rules, partnering with third party vendors to improve upon the single and multi rules, and providing feedback to the third parties based upon performance of related goods and services.

20. A method of risk detection as recited in claim 16, further comprising the step of automatically creating the single and multi rules by a software routine.
